(19) United States
(12) Patent Application Publication
(10) Pub. No.: US 2019/0099241 A1
(43) Pub. Date: Apr. 4, 2019

(54) METHOD AND DEVICE FOR DENTAL VIBRATION

(71) Applicant: Advanced Orthodontics And Education Association, LLC, Ossining, NY (US)

(72) Inventors: Bryce A. WAY, San Jose, CA (US); Richard JOHNSON, Briarcliff Manor, NY (US); Phillip ABATELLI, Wesbury, NY (US); Amin Hadi MIRZAAGHAEIAN, Fremont, CA (US); James SIEG, Ossining, NY (US); Christopher U. PHAN, San Leandro, CA (US); Jonathan L. NICOZISIS, Ossining, NY (US)

(73) Assignee: Advanced Orthodontics And Education Association, LLC, Ossining, NY (US)

(21) Appl. No.: 16/079,818

(22) PCT Filed: Feb. 27, 2017
(86) PCT No.: PCT/US17/19767

§ 371 Date: Aug. 24, 2018

Related U.S. Application Data
(60) Provisional application No. 62/300,705, filed on Feb. 26, 2016.

(51) Int. Cl. A61C 7/00; A61C 7/08; A61C 7/36

(52) U.S. Cl. CPC A61C 7/008; A61C 8/0006; A61C 7/36; A61C 7/08

(57) ABSTRACT

A dental device includes a mouthpiece configured to sit against an orthodontic aligner on a patient's teeth and a motor connected to the mouthpiece. The motor is configured to vibrate the mouthpiece at a frequency between 60 Hz and 130 Hz such that the mouthpiece places an axial vibratory force on the orthodontic aligner.

### CROSS-REFERENCE TO RELATED APPLICATIONS

This application claims priority to U.S. Provisional Patent Application No. 62/300,705, filed Feb. 26, 2016, titled “METHOD AND DEVICE FOR DENTAL VIBRATION,” the entirety of which is incorporated by reference herein.

This application may be related to U.S. patent Ser. No. 13/828,692, filed Mar. 14, 2013, titled “METHOD AND DEVICE FOR INCREASING BONE DENSITY IN THE MOUTH,” now U.S. Patent Application Publication No. 2013-0283490-A1, which claims priority to U.S. Patent Provisional Application No. 61/624,100, titled “METHOD AND DEVICE FOR INCREASING BONE DENSITY IN THE MOUTH,” and filed Apr. 13, 2012, each of which is herein incorporated by reference in its entirety.

### INCORPORATION BY REFERENCE

All publications and patent applications mentioned in this specification are herein incorporated by reference to the same extent as if each individual publication or patent application was specifically and individually indicated to be incorporated by reference.

### BACKGROUND

Dental aligners, such as ClearCorrect™ or Invisalign™, are commonly used to move teeth to a desired location. Unlike traditional braces where the brackets are permanently bonded to the patient's teeth until an orthodontist removes them, aligners are meant to be removed every time the patient eats or brushes his or her teeth. Thus, aligners need to be re-aligned and/or re-applied multiple times a day. Having to refit the aligners each time presents drawbacks because there is likelihood that the aligners are not properly fitted over the patient's teeth. Further, because replacing the aligners after removal can be a hassle, patients may not spend the time necessary to properly seat the aligners over their teeth.

One product currently available for aiding with proper seating of aligners is the Chewies™ aligner seater. Chewies™ aligner seaters are rubberized cotton rolls that are intended to seat aligners up over the dentition. In use, a patient places a Chewies™ aligner seater in his or her mouth after putting in the aligner. The patient then “chews” on the Chewies™ aligner seater. In order for the Chewies™ aligner seater to be effective, the patient is required to provide the proper forces on the Chewies™ aligner seater, which then in turn exerts the force over the aligner to seat it snuggly and properly over the patient's teeth.

Unfortunately, because the Chewies™ regimen is left to the patient without much guidance on how to most effectively use them, there can be great variations on how well the Chewies™ aligner seaters work. For example, the Chewies™ aligner seater may not be effective because a patient may not spend the time necessary to contact the Chewies™ aligner seater to all occlusal surfaces of his or her teeth. Furthermore, the Chewies™ aligner seater may not be able to comfortably reach every top surface of the aligner within the patient's mouth, and thus some areas of the aligner may be seated well, while other areas may not. Additionally, repeated use of the Chewies™ aligner seaters can cause distortion of the aligners at the point of localized force. Further, Chewiest™ aligner seaters can be ineffective if the patient does not use enough force when chewing on the Chewies™ aligner seater, and thus the Chewies™ seater aligner may not be able to optimally seat the aligner. Moreover, seating recommendations range from using Chewies™ aligner seaters only when aligners trays are new (i.e., immediately post change) while others recommend daily seating. With the current seating modalities, it is therefore unlikely that patients consistently seat aligners fully. Improperly seated aligners can slow treatment, at times forcing patients to back track to previous trays, and create unintended collateral tooth movements. Thus, there exists a need for an alternative method of seating aligners that provides more consistent seating of the aligners.

### SUMMARY OF THE DISCLOSURE

The present disclosure relates generally to dental devices. More specifically, the present disclosure relates to dental devices used for seating orthodontic aligners.

In general, in one embodiment, a dental device includes a mouthpiece configured to sit in a patient's mouth between the patient's top and bottom dental arches and a motor connected to the mouthpiece. The motor is configured to vibrate the mouthpiece at a frequency between 60 Hz and 130 Hz such that the mouthpiece places a vibratory force primarily within a sagittal plane in the patient's mouth.

This and other embodiments can include one or more of the following features. The mouthpiece can be configured to sit against an orthodontic aligner on the patient's teeth, and the mouthpiece can include textural and topographical variations that are configured to correspond to surface variations of occlusal surface of aligners over a patient's teeth. The mouthpiece can include a soft, elastomeric material. The mouthpiece can be configured to sit against an orthodontic aligner on the patient's teeth, and the mouthpiece can be configured to contact all occlusal surfaces of the orthodontic aligner. The mouthpiece can further include a removable covering. The mouthpiece can have a U-shape. The dental device can further include a sensor configured to detect the vibration proximate to the occlusal surfaces of the patient's teeth. The mouthpiece can have a tapered thickness from a front of the mouthpiece closest to the motor to a back of the mouthpiece. The mouthpiece can be thicker in the front than in the back. The acceleration can be between 0.01 G and 1.0 G. The dental device can further include a handle attached to the mouthpiece, the motor positioned within the handle.

The mouthpiece can be configured to be removed from the dental device in the ordinary course of usage.

In general, in one embodiment, a dental device includes a mouthpiece configured to sit against an orthodontic aligner on a patient's teeth and a motor connected to the mouthpiece. The motor is configured to vibrate the mouthpiece at a frequency between 60 Hz and 130 Hz such that the mouthpiece places an axial vibratory force on the orthodontic aligner.

This and other embodiments can include one or more of the following features. The mouthpiece can include textural and topographical variations that can be configured to correspond to surface variations of occlusal surface of the orthodontic aligner. The mouthpiece can include a soft, elastomeric material. The mouthpiece can be configured to contact all occlusal surfaces of the orthodontic aligner. The mouthpiece can further include a removable covering. The mouthpiece can have a U-shape. The dental device can further include a sensor configured to detect the vibration proximate to the occlusal surfaces of the patient's teeth. The mouthpiece can have a tapered thickness from a front of the mouthpiece closest to the motor to a back of the mouthpiece. The mouthpiece can be thicker in the front than in the back. The acceleration can be between 0.01 G and 1.0 G. The dental device can further include a handle attached to the mouthpiece, the motor positioned within the handle. The mouthpiece can be configured to be removed from the dental device in the ordinary course of usage.

In general, in one embodiment, a dental device includes a handle, a tapered mouthpiece, and a motor. The tapered mouthpiece is thicker closer to the handle and thins at it moves away from the handle. The mouthpiece is further configured to sit in a patient's mouth between the patient's top and bottom dental arches. The motor is within the handle and connected to the mouthpiece, the motor configured to vibrate the mouthpiece at a frequency between 60 Hz and 130 Hz.

This and other embodiments can include one or more of the following features. The mouthpiece can include can include textural and topographical variations that are configured to correspond to surface variations of occlusal surface of the patient's teeth. The mouthpiece can include a soft, elastomeric material. The mouthpiece can further include a removable covering. The mouthpiece can be customized to fit the patient's teeth. The mouthpiece can have a U-shape. The dental device can further include a sensor configured to detect the vibration proximate to the occlusal surfaces of the patient's teeth. The acceleration can be between 0.01 G and 1.0 G.

In general, in one embodiment, a dental device includes a handle, a motor within the handle, and a drive pin. The motor is configured to vibrate the mouthpiece at a frequency between 60 Hz and 130 Hz. The drive pin extends from the motor out of the handle and is configured to connect to a foam cylinder so as to permit vibration of the cylinder with the motor.

This and other embodiments can include one or more of the following features.

The foam cylinder can include a styrene copolymer.

In general, in one embodiment, a method of seating orthodontic aligners into a desired position includes placing an orthodontic aligner over occlusal surfaces of a patient's teeth; placing a dental device into the oral cavity of a subject against the aligner; and vibrating the mouthpiece at a frequency between 60 Hz and 130 Hz such that the mouthpiece places an axial vibratory force on the orthodontic aligner so as to seat the orthodontic aligner against the occlusal surfaces.

This and other embodiments can include one or more of the following features. Vibrating can include vibrating for less than 5 minutes per day. Vibrating can include vibrating the mouthpiece against all of the patient's teeth that are covered with the orthodontic aligner.

The mouthpiece can place a vibratory force on the orthodontic aligner primarily in a sagittal plane of the patient's mouth.

In general, in one embodiment, a method of improving/encouraging osseointegration of oral implants includes placing a dental device into a patient's mouth that includes an oral implant; selecting a high frequency acceleration program from the dental device to vibrate the dental device; and running the high frequency acceleration program for a predetermined amount of time to improve osseointegration of the oral implant.

This and other embodiments can include one or more of the following features. The high frequency acceleration program can provide an output of 0.3 g, a frequency of 60 Hz, and a loading strain of 4με. The high frequency acceleration program can provide an output of 0.6 g, a frequency of 60 Hz, and a loading strain of 8με.

### BRIEF DESCRIPTION OF THE DRAWINGS

The novel features of the invention are set forth with particularity in the claims that follow. A better understanding of the features and advantages of the present invention will be obtained by reference to the following detailed description that sets forth illustrative embodiments, in which the principles of the invention are utilized, and the accompanying drawings of which:

FIG. 1A shows an exemplary dental device having a mouthpiece and base as described herein. FIG. 1B shows the mouthpiece of FIG. 1A disconnected from the base. FIG. 1C shows an exploded view of the mouthpiece and base of FIG. 1A.

FIG. 2 shows vibration of the dental device of FIG. 1.

FIG. 3A shows an exemplary mouthpiece of a dental device having a motor in the mouthpiece positioned in-line with the mouthpiece extension. FIG. 3B is an exploded view of the mouthpiece of FIG. 3A. FIG. 3C shows placement of the mouthpiece of FIG. 3A in a patient's mouth.

FIG. 3D is a flowchart for a feedback loop used to adjust the frequency or acceleration of vibration of a dental device as described herein.

FIG. 4A shows an alternative exemplary mouthpiece of a dental device having a motor in the mouthpiece positioned horizontal to the mouthpiece extension and inside the biteplate of the mouthpiece. FIG. 4B is an exploded view of the mouthpiece of FIG. 4A. FIG. 4C shows placement of the mouthpiece of FIG. 4A in a patient's mouth.

FIG. 5A shows an alternative exemplary mouthpiece portion of a dental device having a motor in the mouthpiece positioned horizontal to the mouthpiece extension and outside the biteplate of the mouthpiece. FIG. 5B is an exploded view of the mouthpiece of FIG. 5A.

FIG. 5C shows placement of the mouthpiece of FIG. 5A in a patient's mouth.

FIG. 6 is an exploded view of an exemplary base of a dental device described herein.

FIG. 7A shows an exemplary biteplate having raised dimples. FIG. 7B is a cross-section of the biteplate of FIG. 7A.

FIGS. 8A and 8B show a biteplate and separable mouth guard of an exemplary mouthpiece as described herein.

FIGS. 9A and 9B show an exemplary oven for forming a mouth guard as described herein.

FIGS. 10A and 10B show an alternative exemplary oven for forming a mouth guard as described herein.

FIG. 11 shows an exemplary mouth guard having vacuum tubes for forming the mouth guard to a patient's teeth.

FIG. 12A shows an alternative embodiment of a dental device as described herein.

FIG. 12B is another view of the mouthpiece of FIG. 12A. FIGS. 12C-12D show the motor placement in the dental device of FIG. 12A.

FIGS. 13A-13F show an alternative embodiment of a mouthpiece as described herein.

FIGS. 14A-14D show an alternative embodiment of a dental device as described herein.

FIGS. 15A-15B show an exemplary charging station for a dental device as described herein.

FIGS. 16A-16D show an alternative exemplary charging station for a dental device as described herein.

FIGS. 17A-17D show an alternative exemplary charging station for a dental device as described herein.

FIG. 18 shows an exemplary connection system between a mouthpiece and a base for a dental device as described herein.

FIG. 19 shows an alternative exemplary connection system between a mouthpiece and a base for a dental device as described herein.

FIG. 20 shows an alternative exemplary connection system between a mouthpiece and a base for a dental device as described herein.

FIG. 21A shows an exploded view of an exemplary vibrating dental device as described herein. FIG. 21B is another view of the device of FIG. 21B. FIGS. 21C-21D show use of the dental device of FIG. 21A.

FIG. 22 shows an exploded view of an alternative exemplary vibrating dental device as described herein.

FIG. 23A shows a base extension having a pancake motor therein. FIG. 23B shows an exemplary pancake motor.

FIG. 24A shows a side-view of a crescent-shaped biteplate for a dental device as described herein. FIG. 24B shows a front view of the crescent-shaped biteplate of FIG. 24A.

FIG. 24C shows exemplary use a device having the crescent-shaped biteplate of FIG. 24A.

FIG. 25A shows a side-view double-hammer-shaped biteplate for a dental device as described herein. FIG. 25B shows a front view of the double-hammer-shaped biteplate of FIG. 25A. FIG. 25C shows exemplary use of a device having the double-hammer-shaped biteplate of FIG. 25A.

FIG. 26A shows a side view of an elongated biteplate for a dental device as described herein. FIG. 26B shows a front view of the elongated biteplate of FIG. 26A. FIG. 26C shows exemplary use of a device having the elongated biteplate of FIG. 26A.

FIGS. 27A-27C show front, side, and back views, respectively, of an exemplary base for a dental device as described herein.

FIG. 28 shows exemplary use of a device having the base of FIGS. 27A-27C.

FIG. 29A shows the dental device in a patient's mouth prior to use the dental device as a seating device for aligners.

FIG. 29B shows the seated aligners over the patient's teeth after using the dental device.

FIG. 29C shows an exemplary device for use in seating aligners.

FIGS. 30A-30C show an exemplary embodiment of a vibration device including a tapered mouthpiece and reduced profile handle.

FIG. 31 shows an exploded view of the handle of FIGS. 30A-30C.

FIGS. 32A-32D show a vibration device positioned within a charging station.

FIGS. 33A-33C show a vibration handle connected to a cylindrical foam piece.

FIGS. 34A-34B show use of a vibration device to seat aligners.

FIGS. 35A-35E show seated aligners after use of a vibration device.

FIGS. 36A-36C show exemplary user interfaces for an application configured to track usage of a vibration device.

FIG. 37A shows an experimental set-up to test the amount of force applied with a vibratory dental device in the x, y, and z directions.

FIG. 37B is a table showing the experimental results.

### DETAILED DESCRIPTION

Described herein are dental devices. The dental devices have or include a mouthpiece with a biteplate configured to sit over all or a portion of the occlusal surfaces of a patient's teeth. The dental devices can be configured to vibrate at a frequency of less than 300 Hz, such as less than 262 Hz, such as between 60 and 120 HZ, such as between 110 and 130 Hz, such as approximately 120 Hz, and an acceleration between 0.001 g-3.0 g, such as between 0.01 G and 1.0 G, such that the mouthpieces places an axial vibratory force on the occlusal surfaces of the patient's teeth and/or orthodontic aligner. Such force can, for example, seat an aligner, accelerate tooth movement, and/or enhance bone growth.

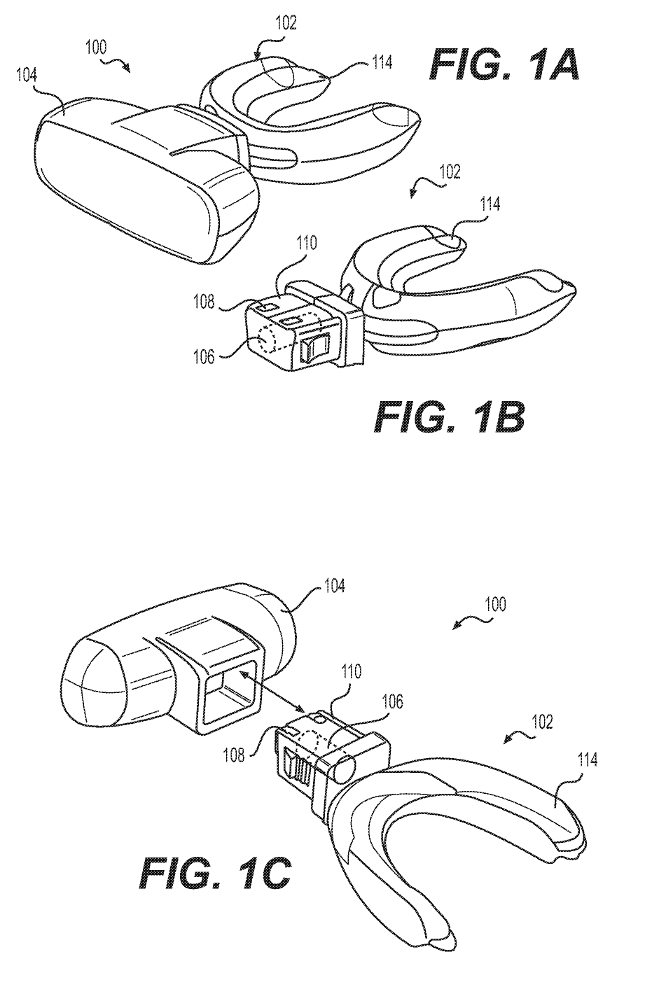

Referring to FIGS. 1A-1C, a dental device 100 includes a mouthpiece 102 having an attached base 104. The mouthpiece 102 can be separable from the base 104. The mouthpiece 102 can include a biteplate 114 (with or without a separate mouth guard there over, as described further below) and a mouthpiece extension 110 configured to connect with the base 104. In one embodiment (as shown in FIGS. 1A-1C), the biteplate 114 can be approximately U-shaped so as to cover the occlusal surfaces of all or nearly all of the patient's teeth. Further, a motor 106 can be located in the mouthpiece 102 and configured to vibrate the mouthpiece 102. The base 104 can include the electronics necessary to run the motor 106. Contacts 108 can electrically connect the base 104 with the mouthpiece 106.

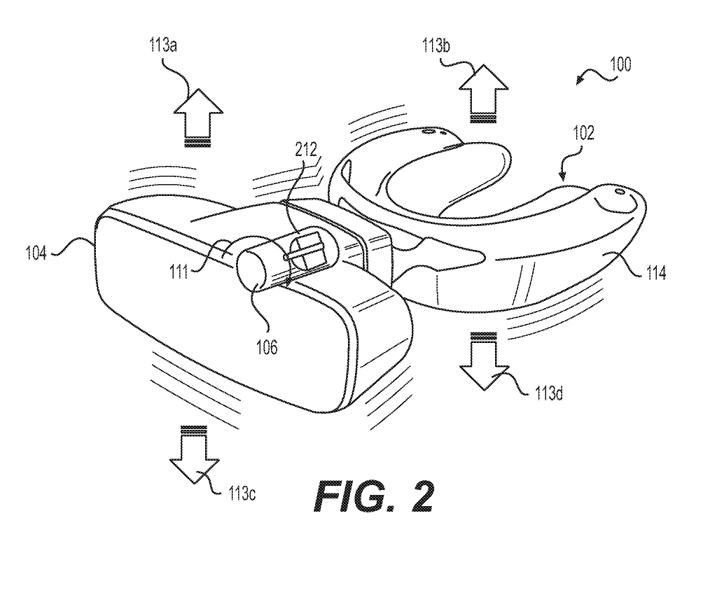

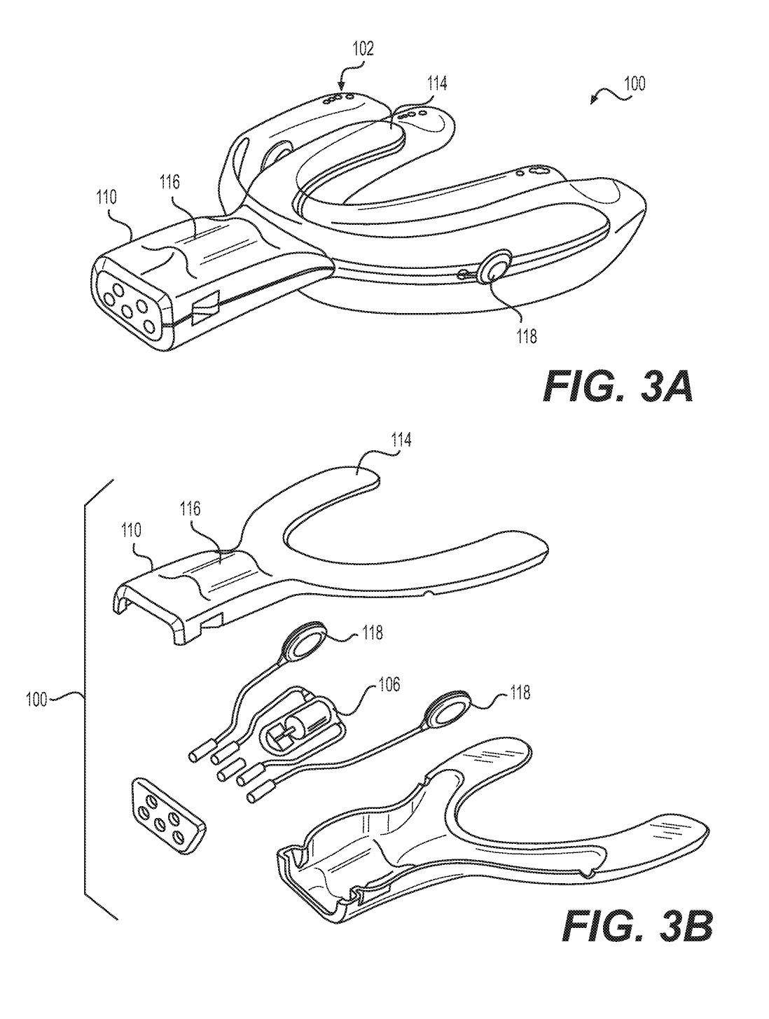

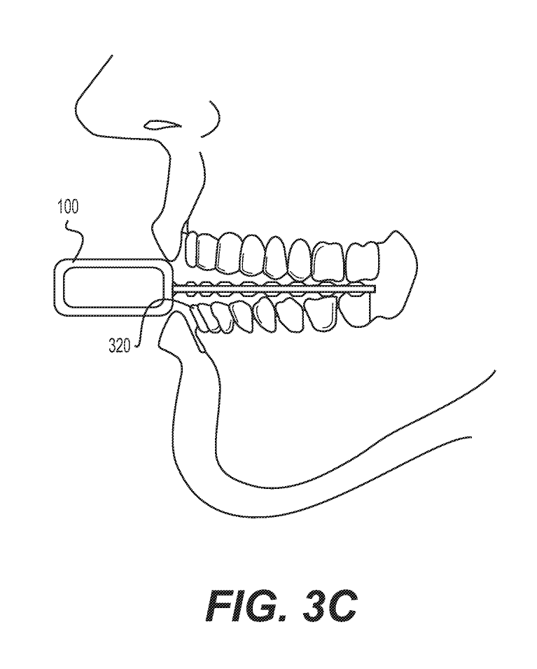

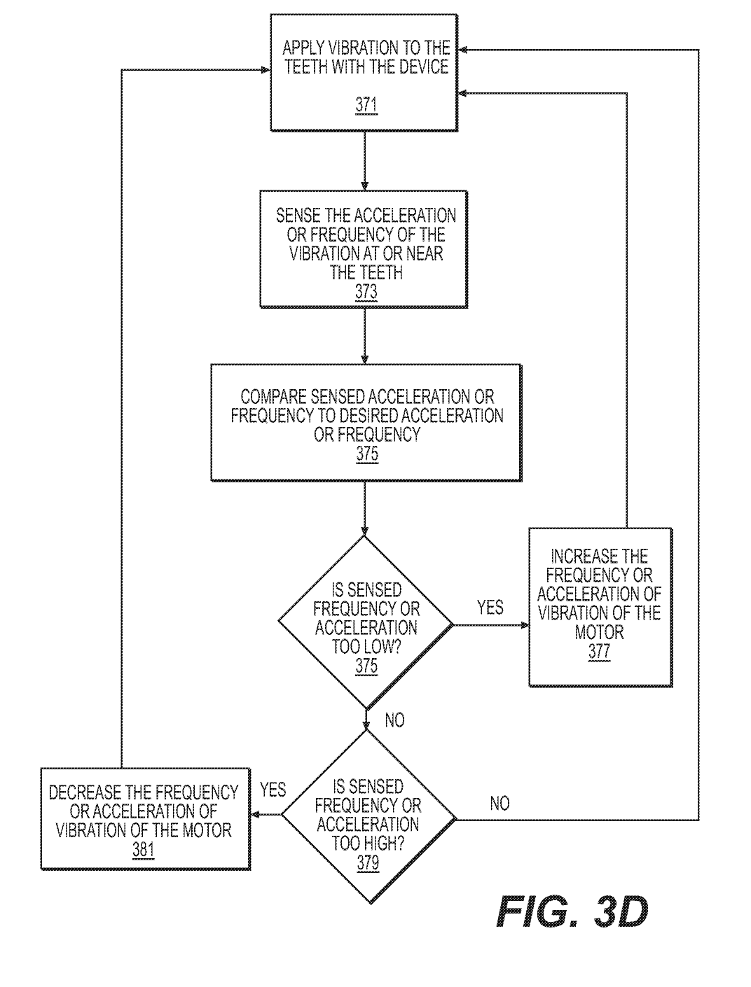

As shown in FIG. 2, the motor 106 can be a counter-weighted motor extending in-line with the extension 110 (i.e. lay horizontal with its longitudinal axis parallel to the longitudinal axis of the extension 110). The motor 106 can include a counterweight 212 that is off-axis from the longitudinal axis of the motor 106. As a result, when the motor 106 rotates, as shown by the arrow 111 in FIG. 2, the counterweight 212 moves up and down, causing the mouthpiece 102 to vibrate up and down, as shown by the arrows 113a-d in FIG. 2. Accordingly, referring to FIG. 3C, when the mouthpiece 102 is placed in a patient's mouth and the dental device is 100 turned on, the vibration of the mouthpiece 102 will place axial vibratory force on the occlusal surface 320 of the teeth or orthodontic aligner placed thereon, i.e., the biteplate 114 will move axially away from the occlusal surface 320 of the teeth or orthodontic aligner and then back onto the occlusal surface 320 of the teeth or orthodontic aligner repetitively. This “smacking” up and down motion can simulate the chewing motion. By simulating the chewing motion, bone in the mouth (e.g., teeth), can be strengthened through the body's natural mechanisms, i.e., bone growth can occur due to the smacking motion. Further, this simulated chewing motion can help to seat an orthodontic aligners against the teeth.

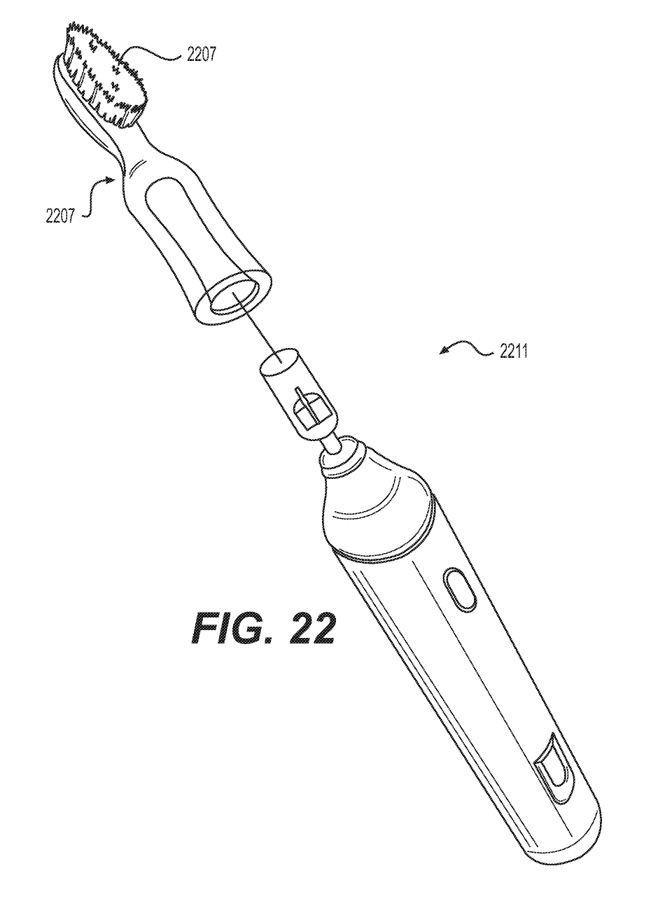

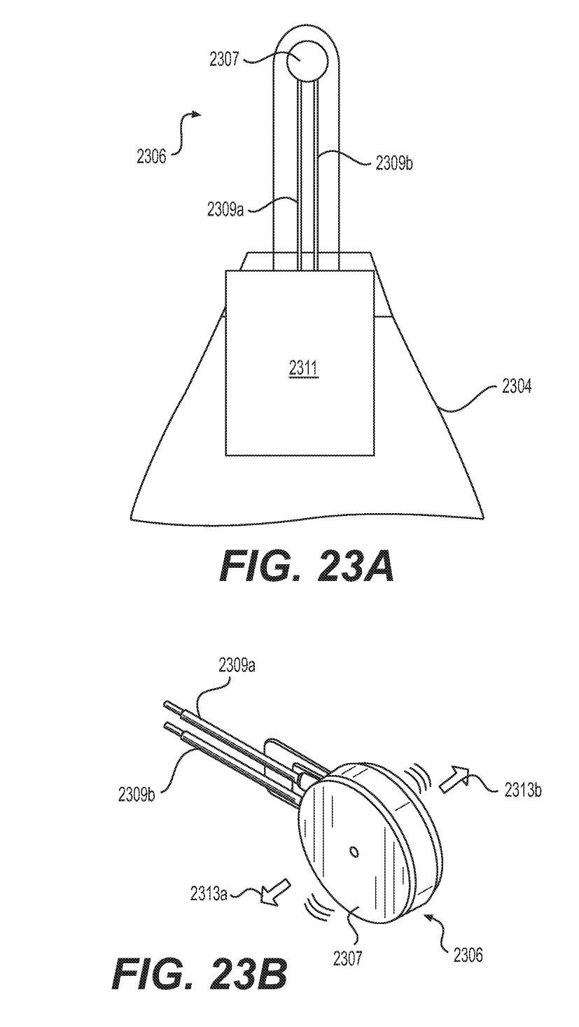

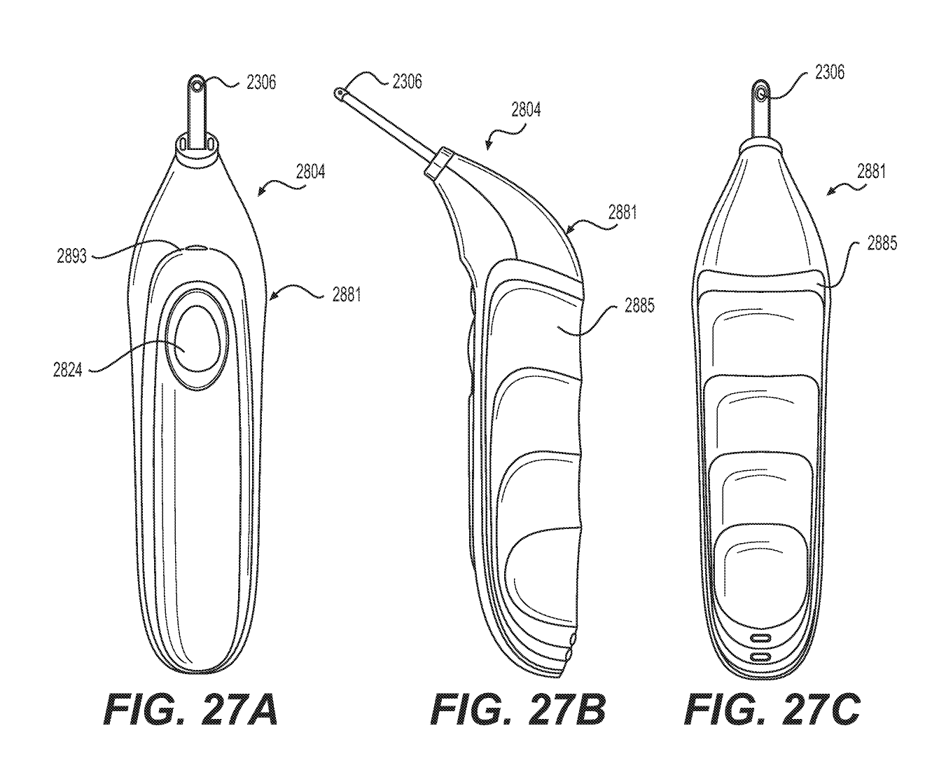

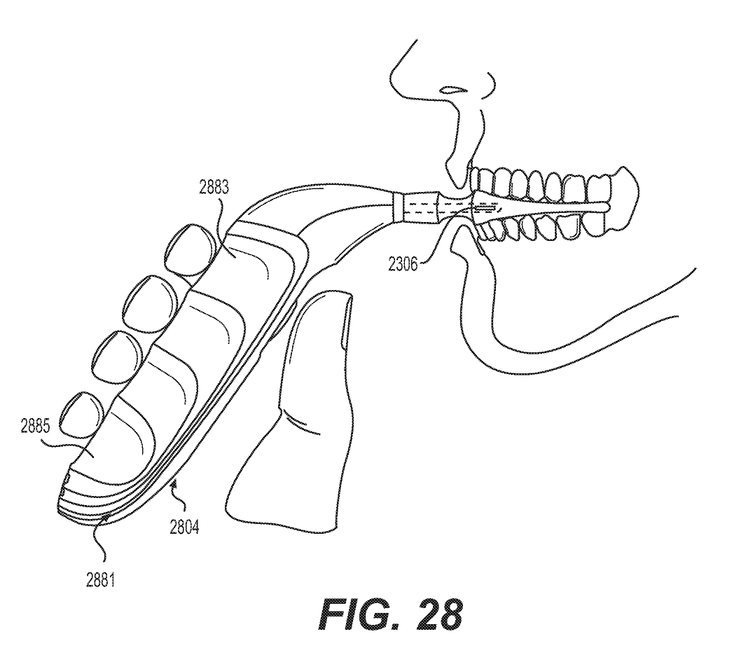

In other embodiments, as shown in FIGS. 23A-23B, the motor 106 can be replaced with a pancake motor 2306 that includes a drum 2307 that moves up and down (shown by the arrows 2313a,b in FIG. 23B). The drum 2307 can be attached to two leads 2309a,b that can connect the drum 2307 with a power source 2311. The pancake motor 2306 can be placed in an extension 2320 on the base 2304, as shown in FIG. 23A (the motor 2306 in an extension of the base is also shown in FIGS. 27A-27C) or can be located with an extension on the mouthpiece. Further, in some embodiments, the pancake motor 2306 can be placed such that the motor extends just inside the teeth, as shown in FIG. 28. Similar to the motor 106, the motor 2306 can place axial vibratory force on the occlusal surface of the teeth, i.e., the mouthpiece can move axially away from the occlusal surface and then back onto the occlusal surface repetitively in a “smacking” motion.

It is to be understood that other types of motors can be used in place of motor 106 or motor 2306 to similarly cause the biteplate 114 to smack the teeth. For example, the motor could be a piezoelectric motor, a linear motor, or an electromagnetic motor. Further, it is to be understood that the motors 106 and 2306 can be interchanged for any of the embodiments described herein. The motors used for the devices described herein can advantageously be small and lightweight. For example, the motor can be less than 2 grams, such as less than 1.5 grams, such as less than or equal to 1.2 grams. Further, the motor can be configured to require low current such that the power requirements are low. For example, the voltage required for the motor to run can be less than 5 volts, such as less than 4 volts, less than 3 volts, or less than 2 volts. In some embodiments, the motor requires between 0.5 and 4 volts, such as approximately 1.5 volts. Further, the motor can advantageously consume less than 250 mW of power, such as less than 200 mW of power and/or can have an operating current of less than 100 mA, such as less than 75 mA, such as less than 65 mA. As a result, the overall device (including the mouthpiece and the base) can advantageously be less than 100 grams, such as less than 75 grams, less than 50 grams, less than 40 grams, or less than 35 grams.

In some embodiments, as shown in FIGS. 3A-3B, the device 100 can include sensors 118, such as piezoelectric sensors, configured to detect the acceleration or frequency of the vibration just proximate to the occlusal surfaces of the teeth. The sensors 118 can be placed, for example, on the outside or the inside of the biteplate. The sensors 108 can be connected to circuitry that includes a feedback loop for running the motor 106. That is, when the mouthpiece 102 touches the teeth, the surface contact and/or force between the mouthpiece 102 and the teeth can dampen the vibrations and/or slow the motor down. The feedback loop can therefore be used to compensate for the slowed motor.

Referring to FIG. 3D, a feedback loop can thus include applying vibration to the teeth with a dental device (such as device 100 or any device described herein) at step 371. The acceleration or frequency of the vibration can be sensed or measured at step 373 at or near the teeth, such as with the sensors 118. The sensed acceleration or frequency can be compared to the desired acceleration or frequency at step 375. At step 375, it can be determined whether the frequency or acceleration is too low. If so, then the frequency or acceleration can be increased at step 377. If not, then it can be determined whether the sensed frequency or acceleration is too high at step 379. If so, then the frequency or acceleration can be decreased at step 381. The feedback loop can then repeat. Thus, the acceleration or frequency of the vibration at the motor can be adjusted to obtain the desired acceleration or frequencies at the mouthpiece 102 regardless of the dampening effect caused by interaction with the teeth.

In one embodiment, shown in FIGS. 3A-3B, the motor 106 can be located within the extension 110 of the mouthpiece 102. Thus, for example, the extension 110 can have a pocket 116 to house the motor 106. The motor 106 can be placed close to the biteplate 114, such as within 1 mm of the biteplate 114, so that the motor 106 is located at least partially within the patient's mouth, i.e., is located intraorally (see FIG. 3C). For example, the counterweight 212 causing the vibration can be positioned so as to be located within the patient's mouth when the dental device 100 is in use. Having the motor 106 located intraorally advantageously both increases the ability of the mouthpiece 212 to smack against the occlusal surfaces of the patient's teeth and/or orthodontic aligner and avoids having the device extend too far outside of the mouth, which can cause discomfort to the patient if the base is intended to be used without hands.

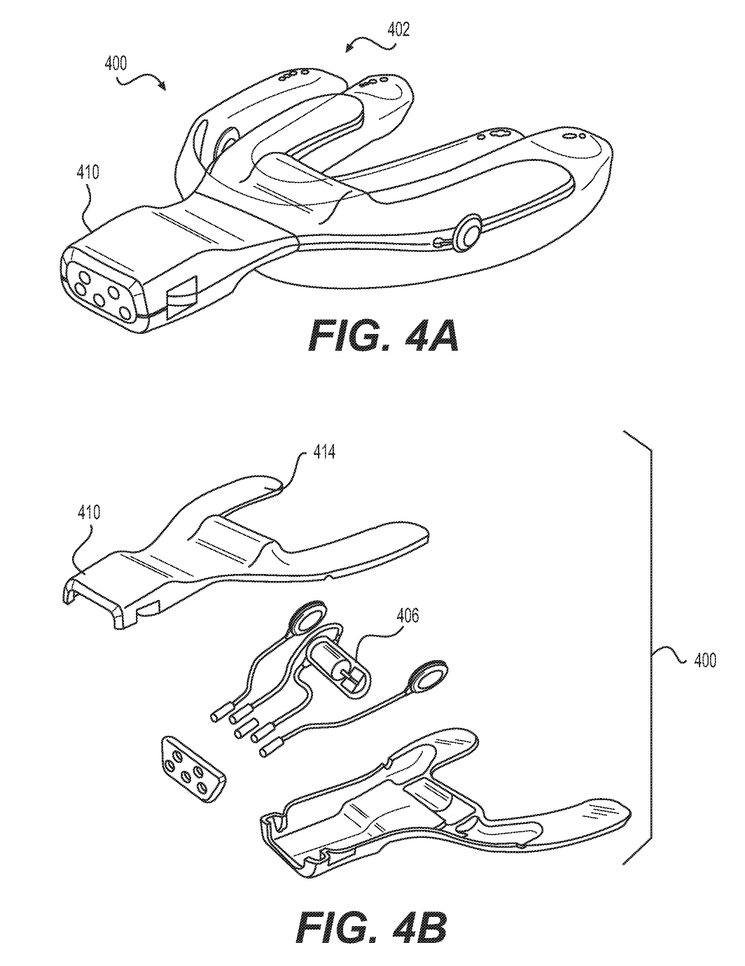

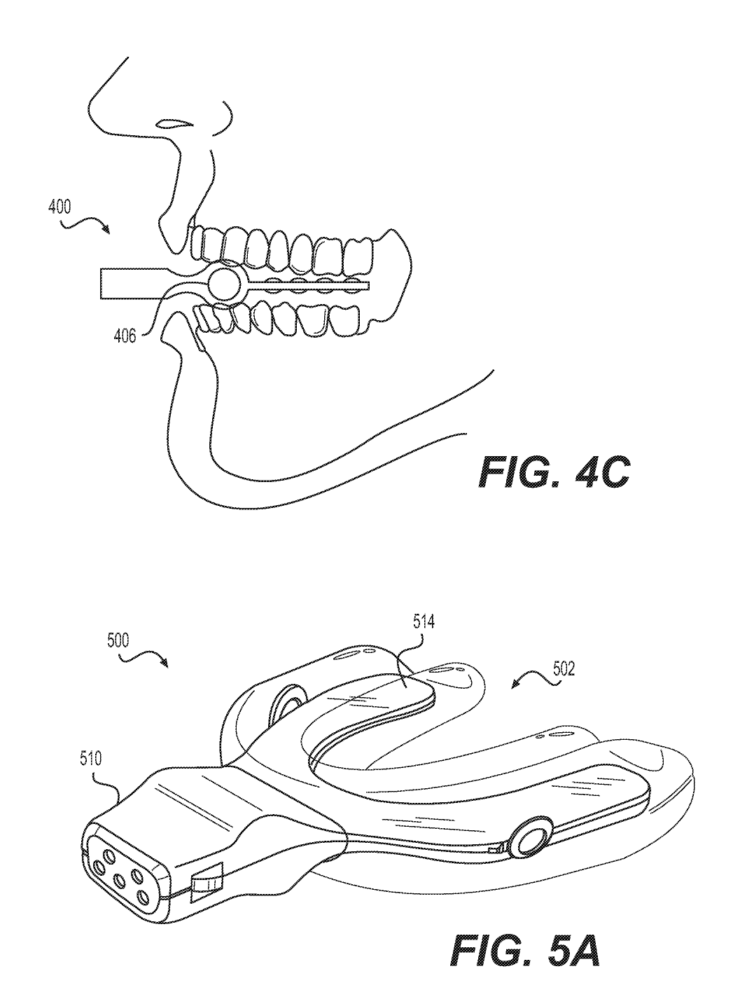

Although the motor has been described as inside of and inline with the extension 410 of the mouthpiece 102, other configurations are possible. For example, referring to FIGS. 4A-4B, in one embodiment, a dental device 400 can have a motor 406 that is located inside of the biteplate 414. Further, the motor 406 can lay horizontal within the extension 410, but be placed such that its longitudinal axis extends perpendicular to the long-axis of the extension 410. The horizontal configuration of the motor still allows the counterweight 212 to provide a smacking motion while the perpendicular configuration allows the motor 406 to be located inside the teeth of a patient's mouth, for example sitting up against the roof of the mouth.

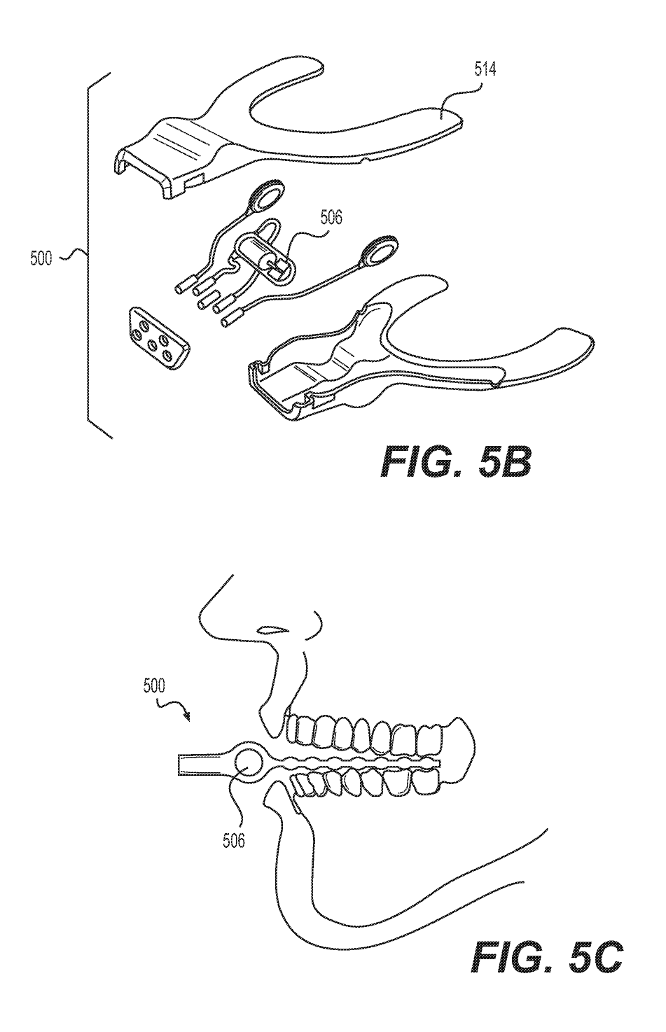

Likewise, referring to FIGS. 5A-5B, the dental device 500 can have a motor 506 that is located inside of the extension and that lays horizontal and perpendicular to extension 510. As described above, the horizontal configuration of the motor allows the counterweight 212 to provide a smacking motion.

In some embodiments, the motors described herein can include an insulator theraround, such as a ceramic sleeve.

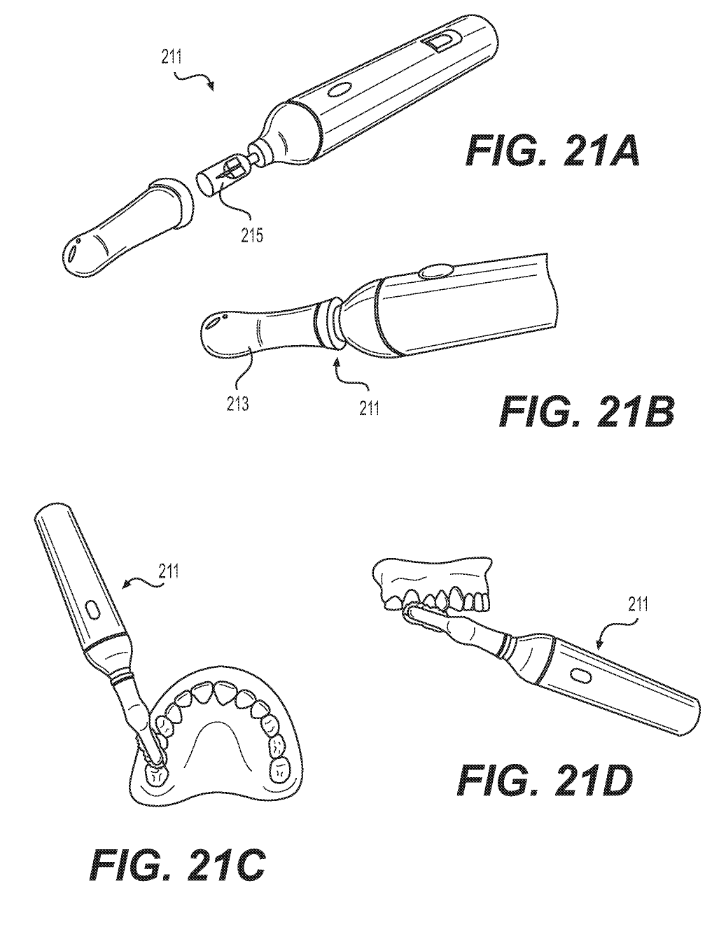

Referring to FIGS. 21A-21D and 24A-26C, the devices described herein need not include a mouthpiece configured to cover all of the teeth. Rather, mouthpieces specifically targeting particular teeth can be used. It is to be understood that the mouthpieces shown and described with respect to FIGS. 21A-21D and 24A-26C can be used with any of the motors, bases, and guards described herein.

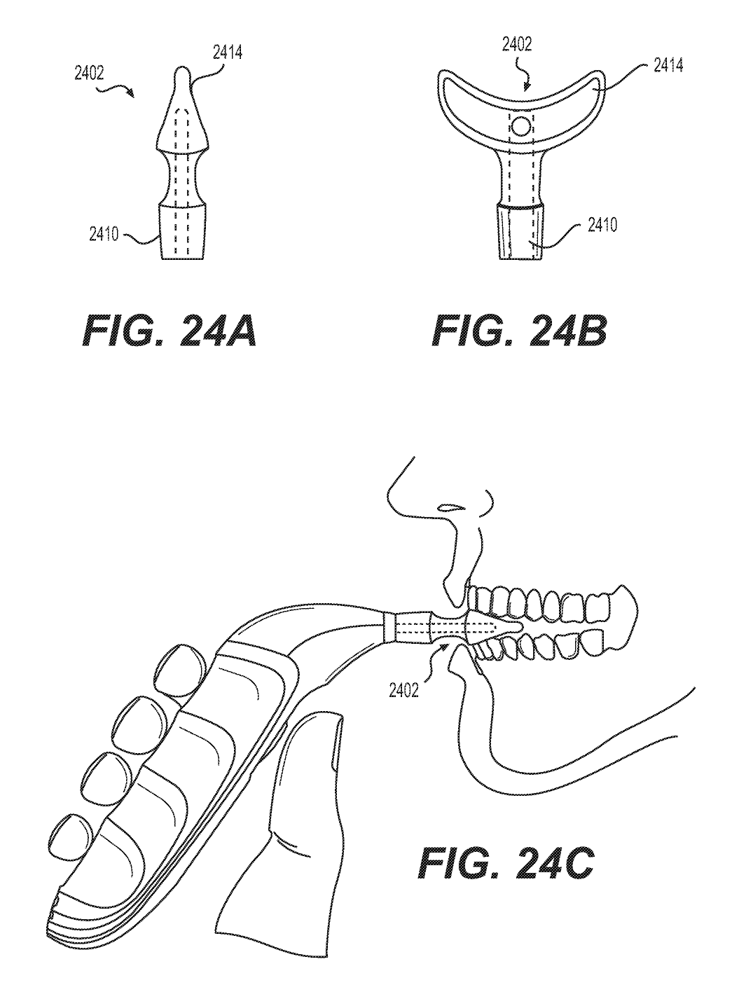

For example, referring to FIGS. 24A-24C, a mouthpiece 2402 can have a crescent shape biteplate 2414 configured to cover the social six teeth. Such a design can be advantageous, for example, for treating crowding in the social six teeth.

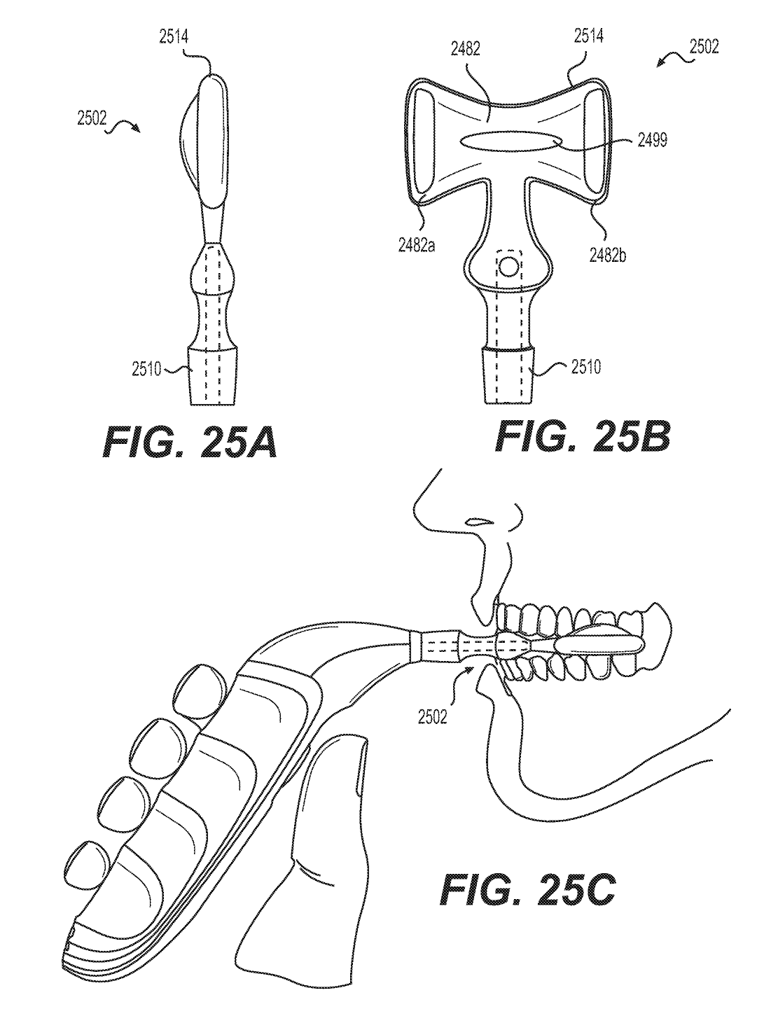

As another example, referring to FIGS. 25A-25C, a mouthpiece 2502 can have a double-hammer-shaped biteplate 2514 configured to cover only the molars. Such a design can be advantageous, for example, for treating molar protraction or retraction. The biteplate 2514 can thus include a narrow central portion 2482 configured to rest on the tongue and two elongated edge portions 2484a,b configured to rest on the occlusal surfaces of the molars. Further, the central portion 2482 can include a convex section 2499 configured to sit over the tongue for comfort and ease of use.

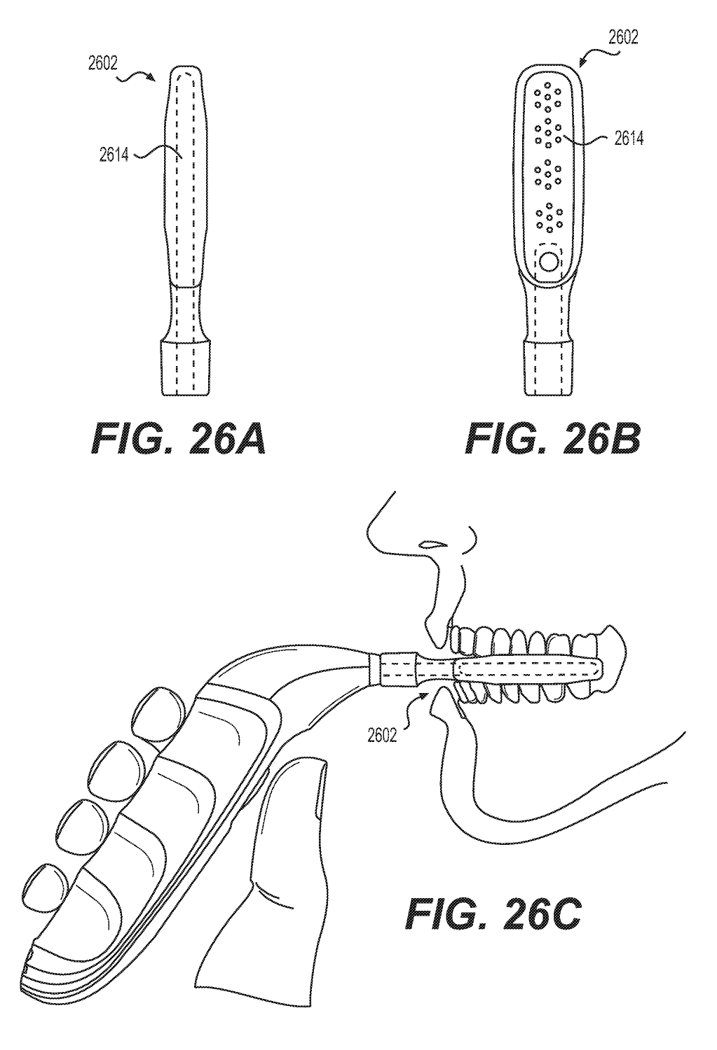

As another example, referring to FIGS. 26A-26C, a mouthpiece 2602 can have an elongate biteplate 2614. The elongate biteplate 2614 can be configured to be placed on one side of the mouth and/or one quadrant of the teeth.

As another example, in one embodiment, shown in FIGS. 21A-21D, the device 211 can include a rounded end or nub 213. The nub 213 can include the motor 215 therein, which can be configured similarly to the motors described above. As shown in FIGS. 21C-21D, by having only a nub 213 rather than a full mouthpiece, specific individual teeth in need of treatment can be targeted. Variations on the nub are possible. For example, referring to FIG. 22, the nub 2213 on device 2211 can include a brush 2207 on the end configured to provide a more gentle vibratory force on the teeth.

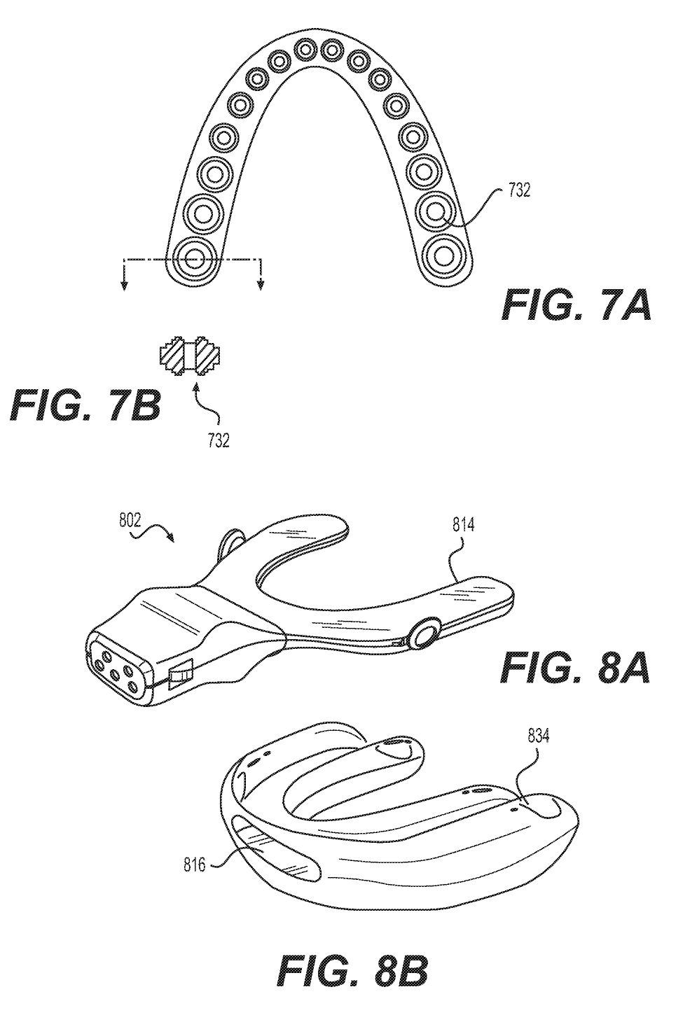

Referring to FIGS. 7A and 7B, the biteplate 714 for any of the mouthpieces described herein can include raised dimples 732, or outward extensions. There can be approximately one dimple 732 for each tooth intended to be treated. Further, the dimples 732 can be spaced apart in such a manner as to approximately align with the center of some or all of the occlusal surfaces of a patient's teeth when the mouthpiece is in use. The dimples 732 can advantageously help the mouthpiece effectively smack the teeth by providing an extended point of contact to ensure that contact is made with each tooth. In some embodiments, the dimples 732 can be customized to a patient's tooth alignment. Each dimple 732 can have a peak that has a surface area of less than 70%, such as less than 50%, of the surface area of the corresponding tooth so as to place pressure on less than 75% or less than 50% of each tooth.

Referring to FIG. 8, the mouthpiece 802 (which can correspond to any mouthpiece described herein) can include two separable parts, the biteplate 814 and a mouth guard 834. The biteplate 814 can be made of a hard material, such as metal. The mouth guard can be made of a softer material such as a polymer.

In some embodiments, the mouth guard 834 can be custom fit to the patient's mouth. By having a custom fit mouth guard 834, the mouthpiece 802 can be more efficient and effective in applying the vibratory smacking force on a patient's teeth. As shown in FIG. 8, the mouth guard 834 can include a hole 836 which can be used to place the mouth guard 834 over the biteplate 814 after formation.

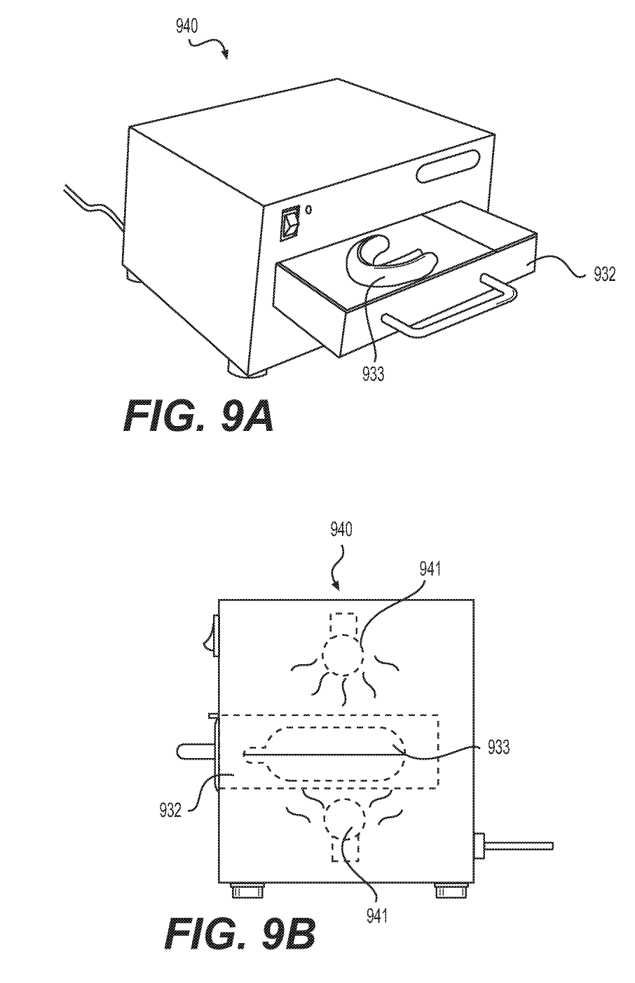

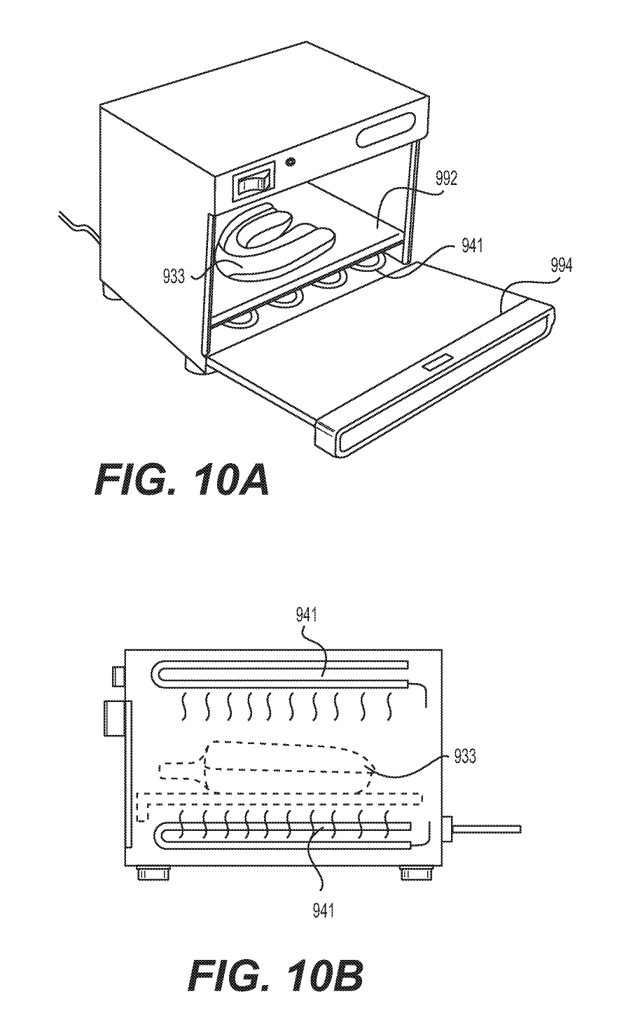

Referring to FIG. 9, the mouth guard 834 can be produced quickly and easily on-site, e.g., at a dentist's office, within minutes by using an oven 940. To form a mouth guard 834 using the oven 940, the mouth guard 834 can be made of a material such as silicone or an ethylene vinyl acetate copolymer, e.g., Elvax®, that is easily formable once warm. The oven 940 can include a heat source 941, such as infrared bulbs, a heat lamp, or heating coils, configured to heat up the mouth guard 814. A mouth guard preform 933 (i.e. one not yet formed to the teeth) can be placed around a biteplate (which can be any of the biteplates described herein) and in the oven 940. The mouth guard preform 933 and biteplate can be exposed to the heat source 941 for between 1 and 10 minutes at temperatures of between 120° and 200° F., less than 200°, or less than 175°. Advantageously, as the mouth guard preform 933 warms, it can become slightly softer, thereby conforming to the shape of any dimples in the biteplate without losing its overall shape. Further, once the mouth guard preform 933 is warmed up sufficiently, the user can take the mouth guard preform 933 out of the oven 940 and have the patient bite down, leaving an impression of the teeth in the mouth guard preform 933. Advantageously, by using temperatures of between 120° and 200° F., less than 200°, or less than 175° to heat the mouth guard, the mouth guard preform 933 will be cool enough upon entering a patient's mouth to not burn the patient (in contrast to temperatures, for example, of over 212°). After the patient has bit down, and as the mouth guard preform 833 cools, it will retain its shape, thereby forming the final mouth guard 834.

The oven 940 can have a variety of configurations. In some embodiments, the oven 940 is relatively small such that it can easily sit on a counter or table at the office. In some embodiments, the oven 940 can include a drawer 932 with a handle, and the drawer 932 can be configured to hold the mouth guard preform 933. In another embodiment, the oven 940 can include a shelf 992 and a hinged door 994. The oven 940 can further include a power switch, an indicator light, a timer, and/or a display to enhance ease of use.

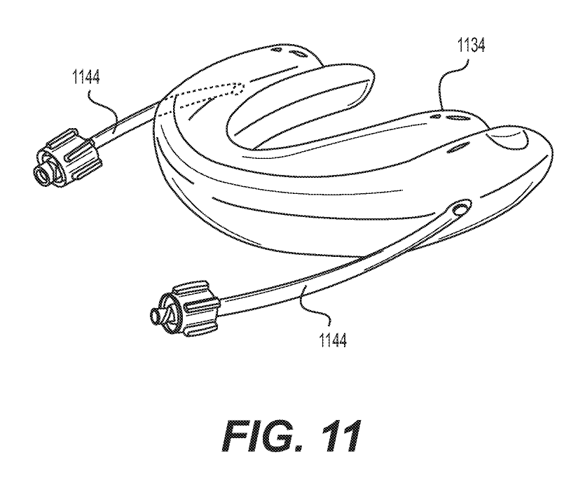

In some embodiments, shown in FIG. 11, the mouth guard 1134 can have vacuum ports 1144 to provide suction to exactly fit the mouth guard 1134 to all of the surfaces of the teeth before the mouthpiece 1134 cools completely. The vacuum ports 1144 can be removed after the mouth guard 1134 is fully formed.

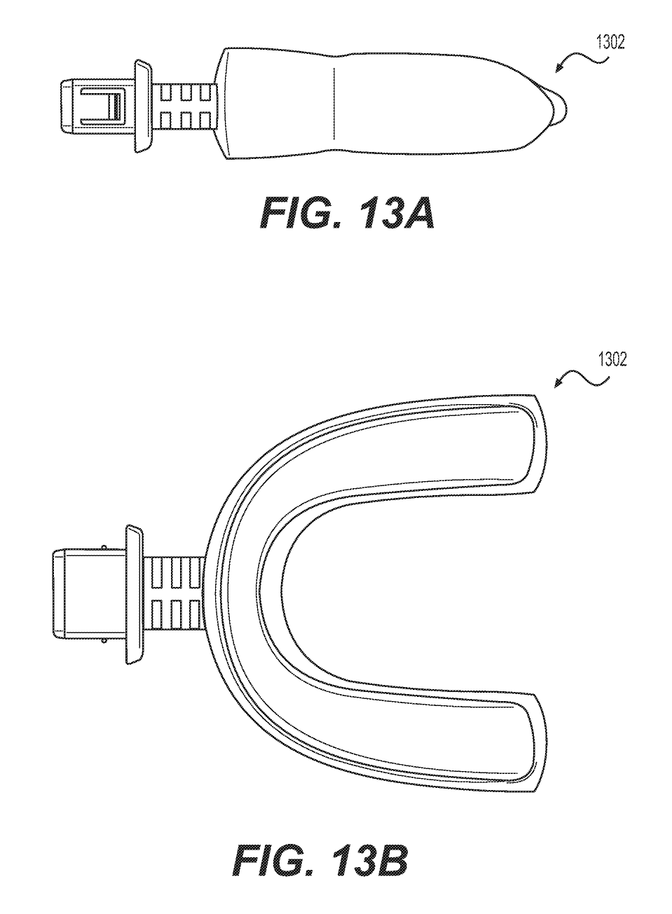

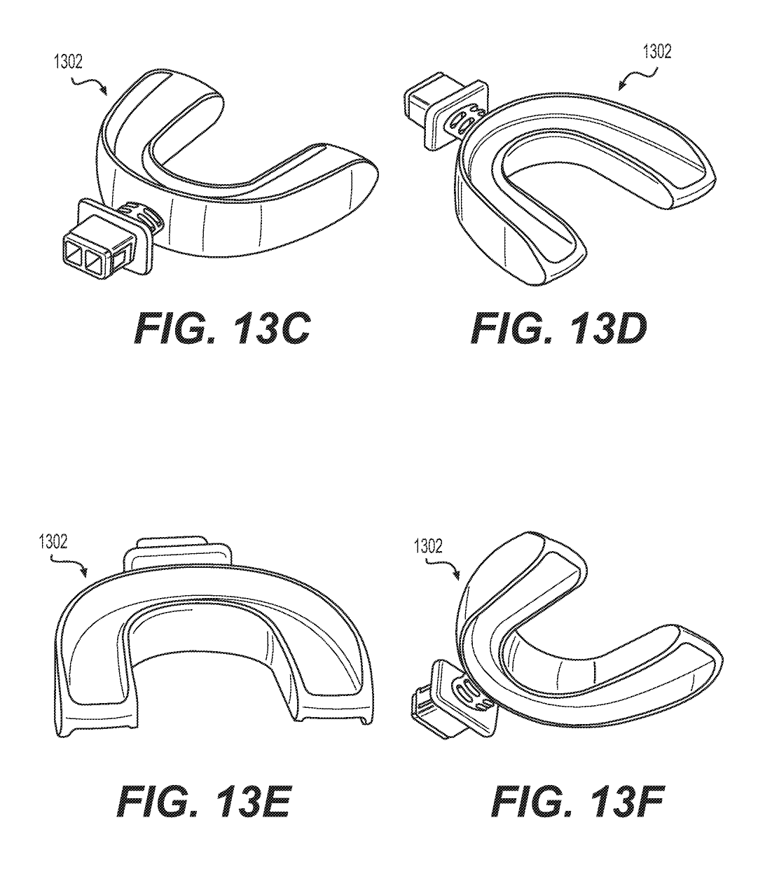

As shown in FIGS. 13A-13F, a mouthpiece 1302 of the dental devices described herein need not be formed to a patient's mouth, but can have a set shape. Further, as shown in FIGS. 13A-13F, the mouthpiece need not include a separate biteplate and mouth guard. Rather, the mouthpiece can be formed of a single piece.

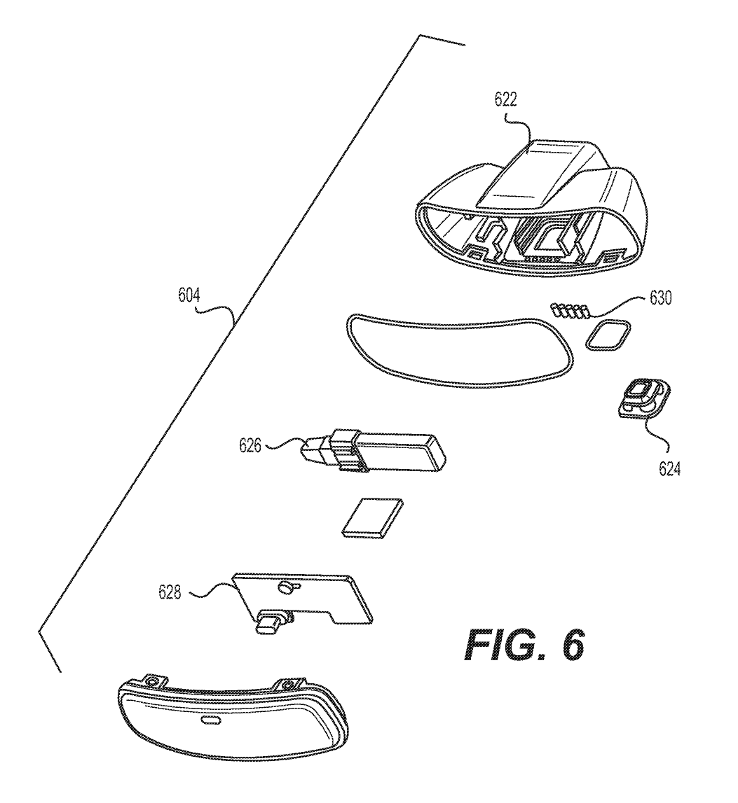

Any of the mouthpieces described herein can be connected to a base, such as base 104 or an alternative base. For example, referring to FIG. 6, a base 604 can be connected to any of the mouthpieces described herein. The base 604 can include a housing 622, an on-off switch 624 to control the vibration, electrical contacts 630 to electrically connect the base 604 with a mouthpiece, a battery 626 to power the motor, and a circuit board 628 to control the motor. The base 604 can be shaped such that it is easily held by a patient's hand. In one embodiment, the base 604 is small and light enough that it does not need to be gripped by the patient during use of the device.

As another example, referring to FIGS. 27A-28, a base 2804 can be connected to any of the mouthpieces described herein. The base 2804 can include a handle 2881 configured to be easily held by a single hand and a mouthpiece connector 2887. The handle 2881 can include a grip portion 2885 that can include indents 2883, such as four indents, configured to provide comfortable resting spot for a person's fingers when gripping the handle 2881. As shown in FIG. 28, the handle 2881 can be curved such that the grip portion 2885 can be gripped with a hand without having to tilt the device forward or up. For example, the angle between the grip portion 2885 and the mouthpiece connector 2887 can be between 30 and 60 degrees, such as approximately 45 degrees. Referring back to FIGS. 27A-27C, the base 2804 can house the power source, such as a battery, for the motor therein. The base 2804 can include an on-off switch 2824 to control the vibration. Further, in some embodiments, the base 2804 can include a battery indicator light 2893 thereon to indicate the amount of battery left. In some embodiments, the base 2804 can also include contacts 2891 thereon to interact with a charging station, as described below. Additionally, some embodiments can include an LED progress indicator as described with respect to FIG. 27A-28 or 31.

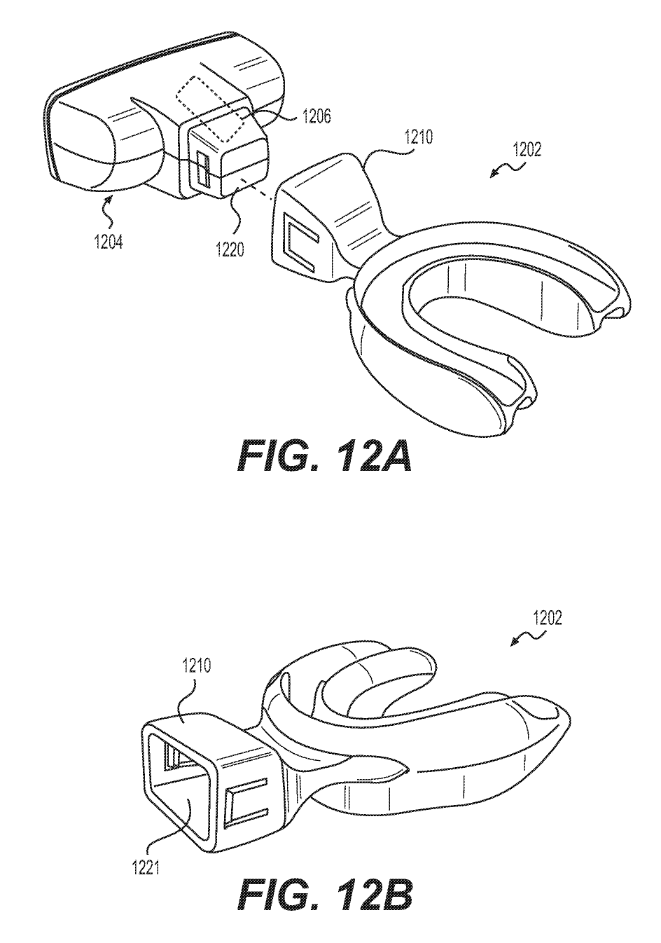

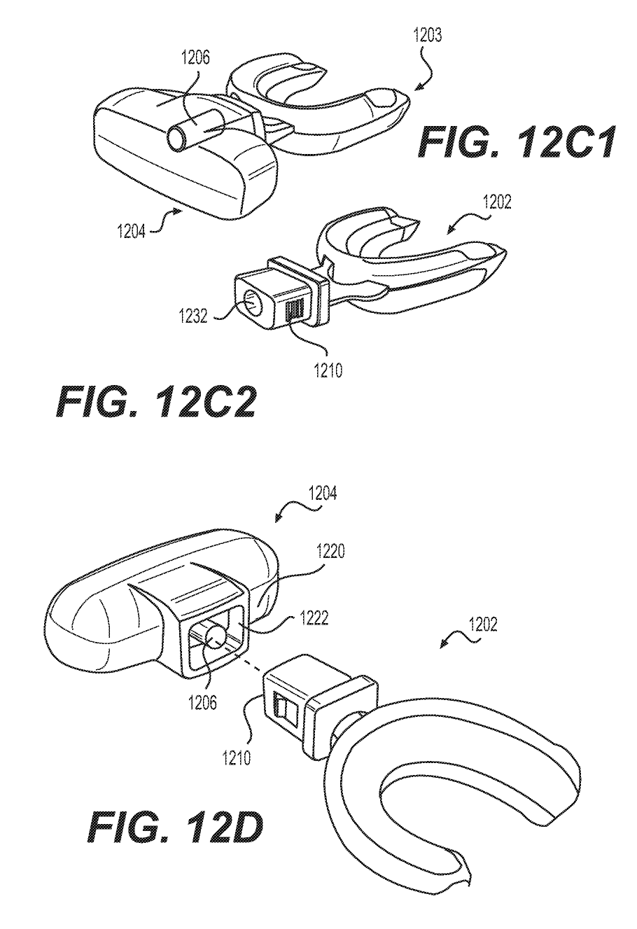

Referring to FIGS. 12A-12D, another exemplary base 1204 can be used with any of the mouthpieces described herein. As shown in FIGS. 12A-12D, the base 1204 can include a motor 1206 therein (in place of or in addition to the motor in the mouthpiece). By including the motor in the base, there is advantageously more room for the connection to the battery while allowing the mouthpiece to be as slim as possible. For example, the mouthpiece 1202 can be free of a motor.

As shown in FIGS. 12A-12D, and 18-20 the mouthpieces can be configured to connect to the base in a variety of ways. For example, as shown in FIGS. 12A-12B, the base 1204 can include an extension 1220 to house the motor 1206, while the extension 1210 of the mouthpiece 1202 can include a hole 1221 therein to fit over or house the extension 1220 of the base 1204. In contrast, in reference to FIGS. 12C-12D, the base 1204 can include an extension 1220 having a hole 1222 therein that both holds the motor 1206 and engages with our houses the extension 1210 of the mouthpiece 1202. The extension 1210 of the mouthpiece 1202 can include a corresponding cut-out 1232 to fit over the motor 1206 when it is snapped into the base 1204.

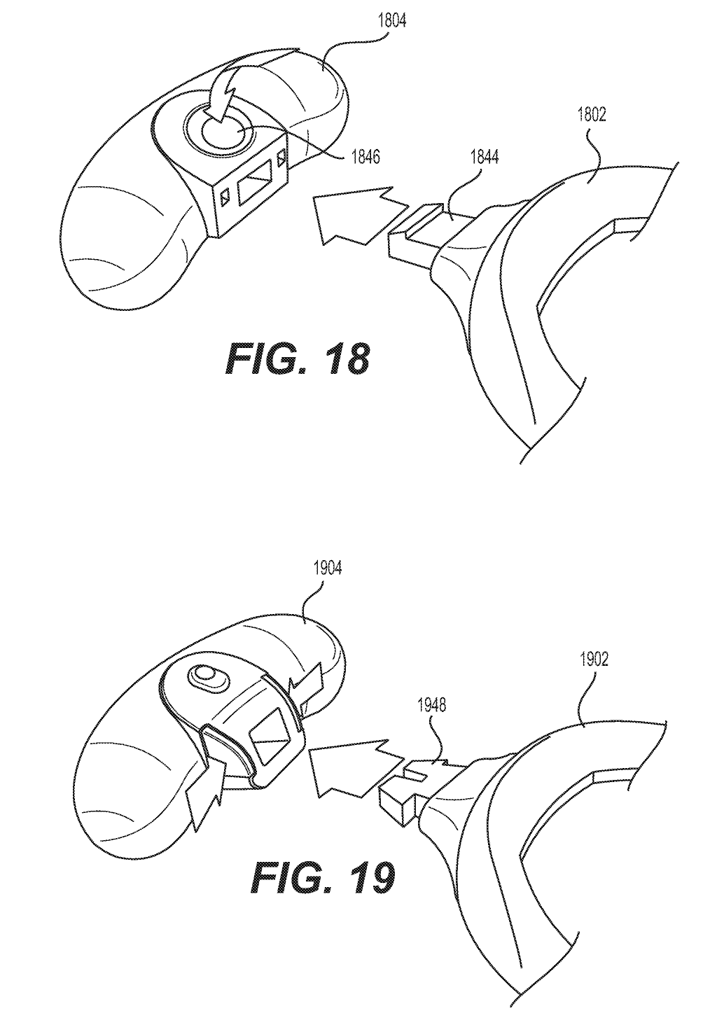

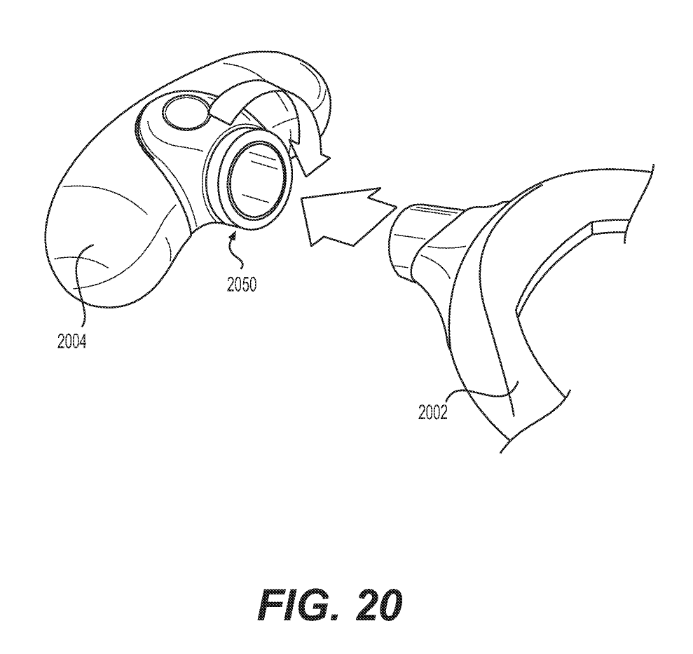

In one embodiment, as shown in FIG. 18, the base 1804 and the mouthpiece 1802 can be attached together with a mechanical connector 1844 that can set the orientation of connection and that can be released through a release button 1846. In another embodiment, shown in FIG. 19, the base 1904 and the mouthpiece 1902 can be attached together through a fork-type mechanical connection 1948; squeezing the fork portions together can lock or unlock the connection 1948. In yet another embodiment, shown in FIG. 20, a tightening collar 2050 can be used to connect a base 2004 and mouthpiece 2002.

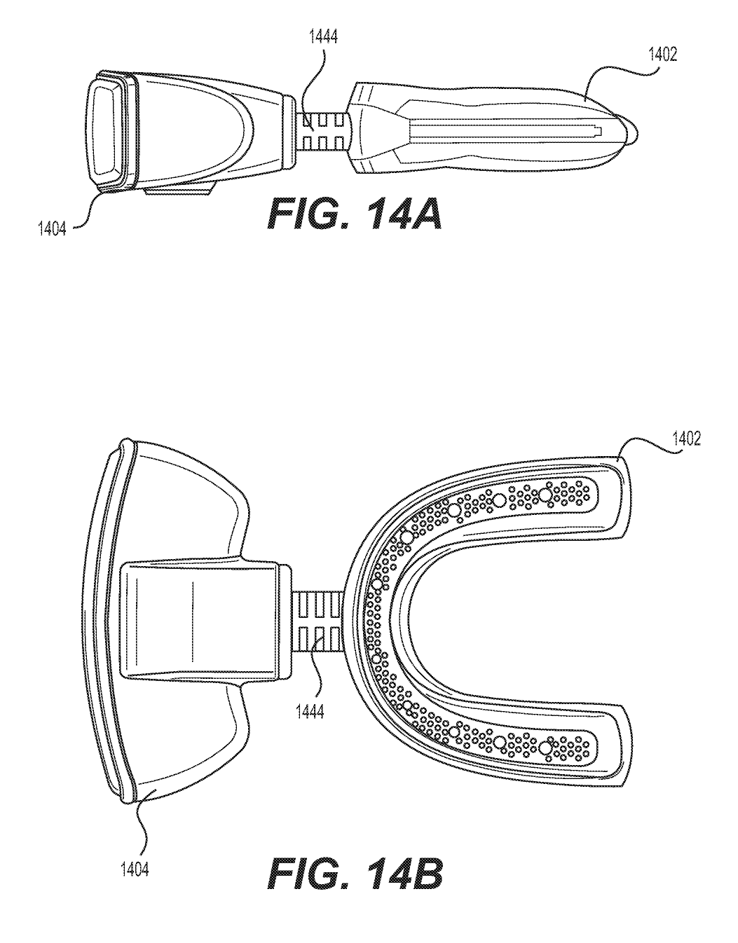

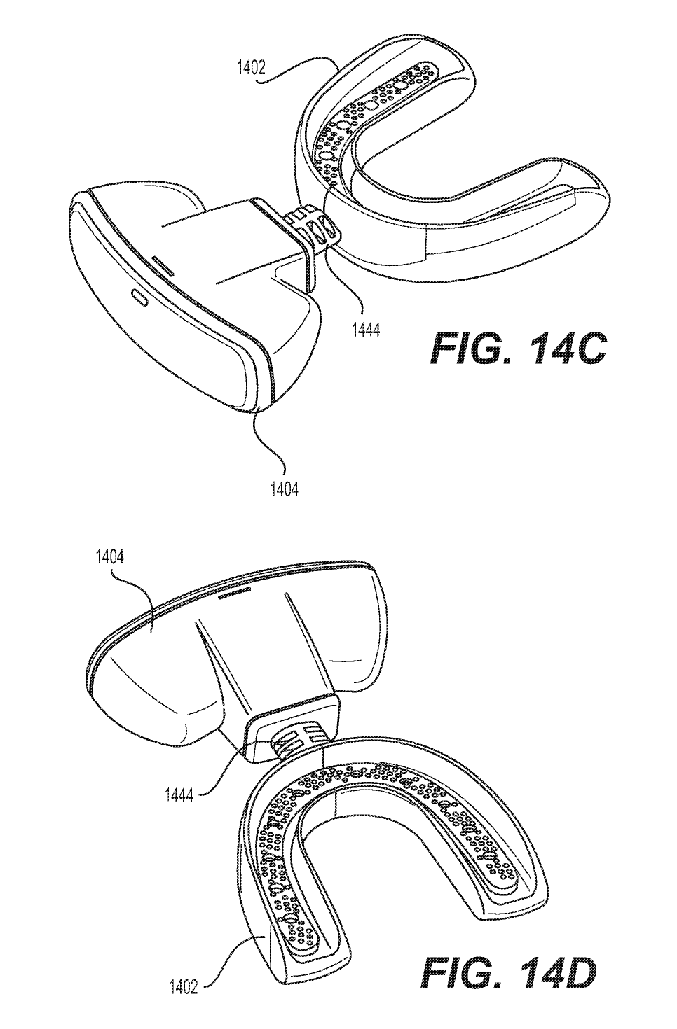

Further, as shown in FIGS. 14A-14B, in some embodiments, the dental devices described herein can include a flexible portion 1444 between the mouthpiece 1402 and the base 1404. For example, the flexible portion 1444 can include a series of cut-outs that allow the portion 1444 to easily bend. The flexible portion 1444 to provide enhanced comfort to the patient, for example, by limiting the amount of vibration that occurs outside of the mouth and by reducing the amount of torque that occurs on the mouth through the bite plate if the base is torqued suddenly. The flexible portion can have an oval-like cross-section that easily conforms to the patient's mouth, thereby enhancing the comfort of the patient.

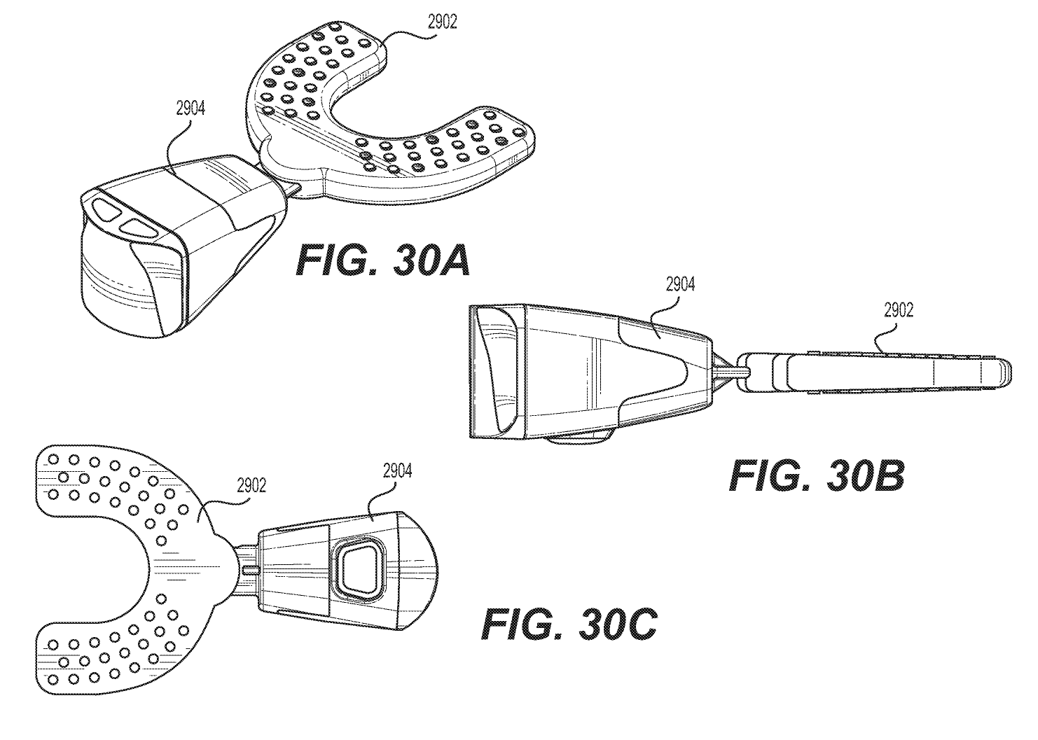

As shown in FIGS. 30A-30C, the dental devices described herein can include a tapered mouthpiece 2902. That is, the mouthpiece 2902 may be thicker in the front (where it touches to the front teeth) and taper to a slimmer dimension in the back (where it reaches the back teeth, e.g., the molars). Thus, the mouthpiece 2902 can have an overall wedge-shaped profile. In some examples, the mouthpiece 2902 may have a maximum thickness in front of between 6.3 mm and 10 mm, and a minimum thickness of between 4 mm and 7.7 mm in the back, with a gradient of between 0 degrees (no gradient) to about 8 degrees. Having this tapered contour can help the mouthpiece 2902 sit better within the dentition (which has a wider opening at the front of the mouth than the back).

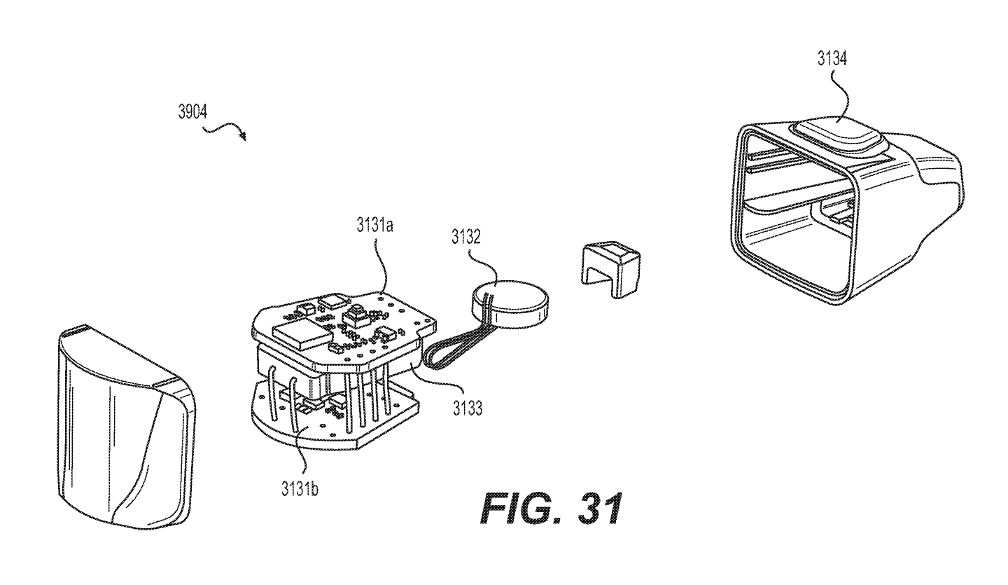

As is shown in FIGS. 30A-30C, the base 2904 of a dental device as described herein can have a small nearly-rectangular base. For example, the base can have a volume of less than 5 cubic inches, such as less than 4 cubic inches, such as less than 3 cubic inches. As shown in the exploded view of FIG. 31, the base 2904 can include a shell 3130 including an on-off button 3134, two circuit board 3131a,b, a small battery 3133 therebetween, a small motor 3132, and a communication sensor, such as Bluetooth, RFID, or LED communicator, configured to communicate information about the device (e.g., use of the device and/or presence of the device in a charger) to a complimentary device, cell phone, or controller. The base 3904 can be connected and disconnected from the mouthpiece 2902 through, for example, a snap fit.

Referring still to FIGS. 30A-30C, in some embodiments, the mouthpiece 2902 can have only portions that touch the occlusal surfaces of the teeth, i.e., without a lip portion extending around the edges. Having little restrictive vertical limitation allows more complete and better aligner contact regardless, for example, of an unusually deep bite.

Further, in some embodiments, the mouthpiece can include both an outer mouth guard and an inner biteplate. The mouth guard can be made of a high durometer plastic material, such as an ethylene-vinyl acetate (EVA) resin while the inner biteplate can be made of a metal. By having an outer mouth guard made of a high durometer material, the exterior is advantageously able to transfer energy more efficiently to the surfaces (e.g., the occlusal surfaces) of the teeth and/or aligners. Likewise, by having a rigid biteplate, the biteplate can carrier greater energy distal from the actuator/motor in the base 2904, allowing enhanced vibration (e.g., for seating aligners) in the molar region.

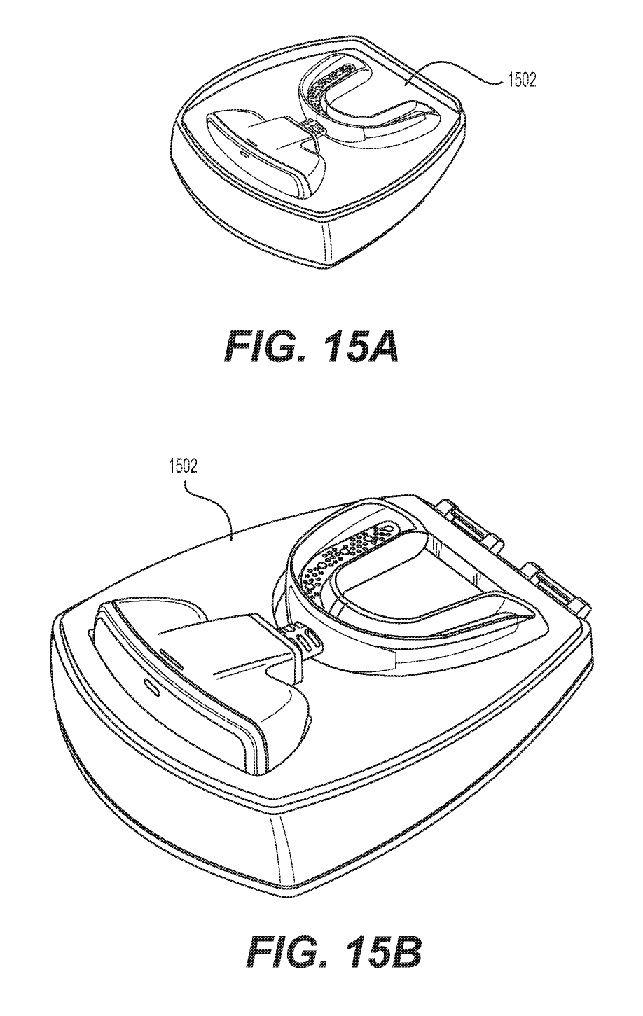

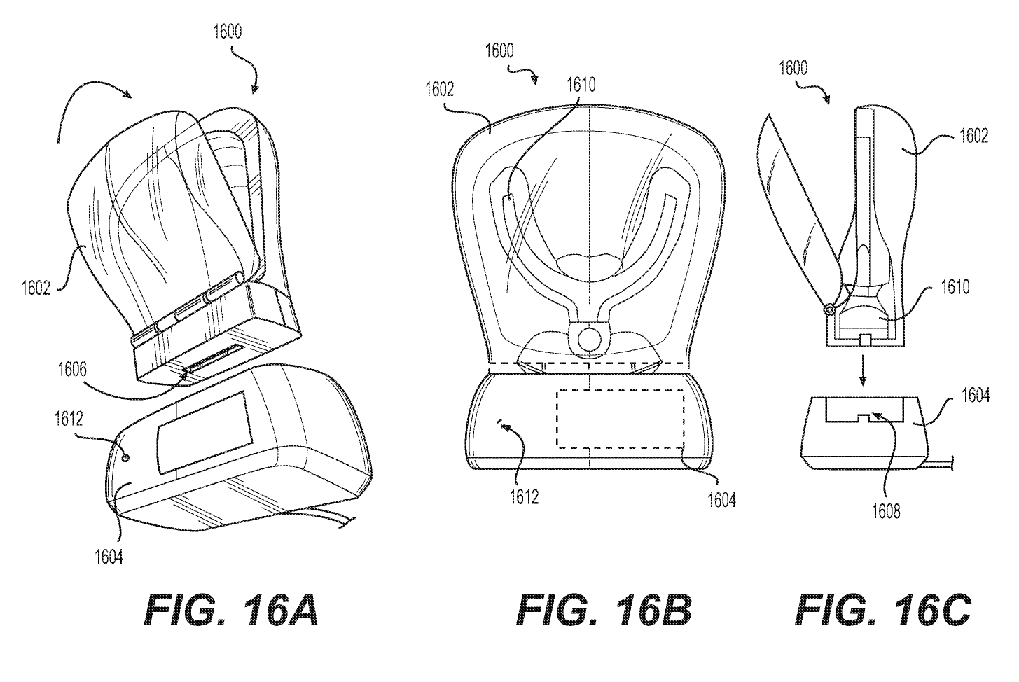

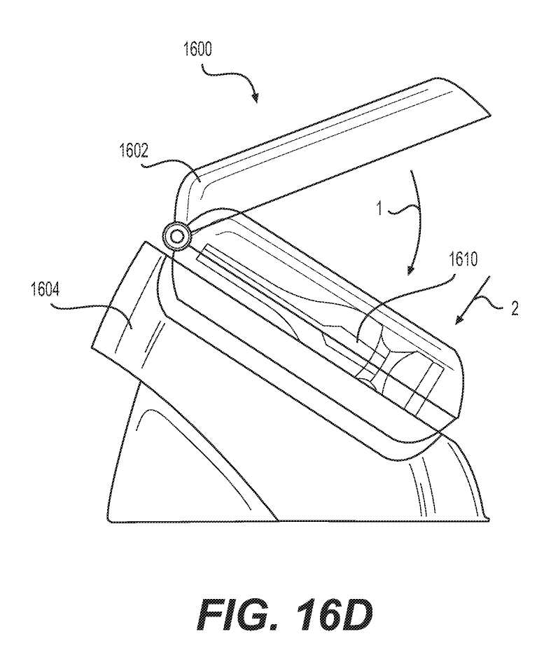

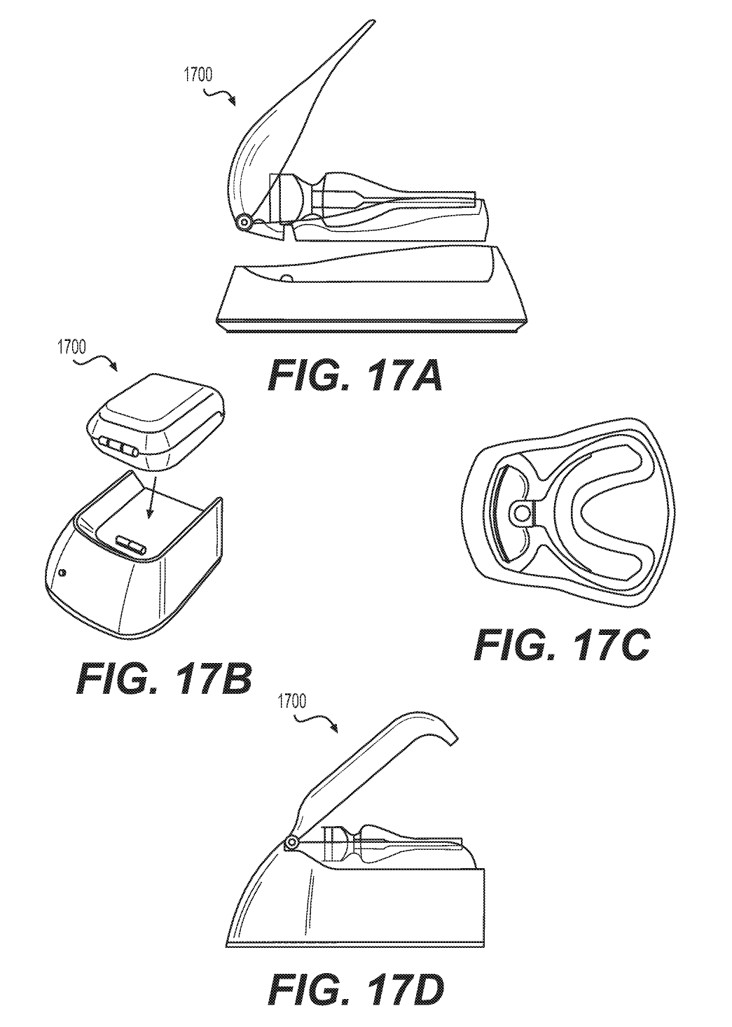

As shown in FIGS. 15-17, the devices described herein can be configured to be charged in a charging station, for example using a standard mini usb connection. As shown in FIG. 15A, the charging station can include a protective covering 1502 configured to protect the device while not in use. The protective covering 1502 can then be placed in a charging base (not shown in FIGS. 15A-15B). As shown in FIGS. 16A-16D, the charging station 1600 can include a protective covering 1602 and a charging base 1604. A connector slot 1606 can be used to sit the case 1602 in the charging base 1604. As shown in FIG. 16C, charging pins 1608 can connect from the charging base 1604 through the protecting covering 1602 and into the device 1610 to charge the device. An indicator light 1612 can indicate whether the charging station 1600 is charging. A similar station 1700 is shown in FIGS. 17A-17D. It is to be understood that other sizes, shapes, and types of charging stations could be used.

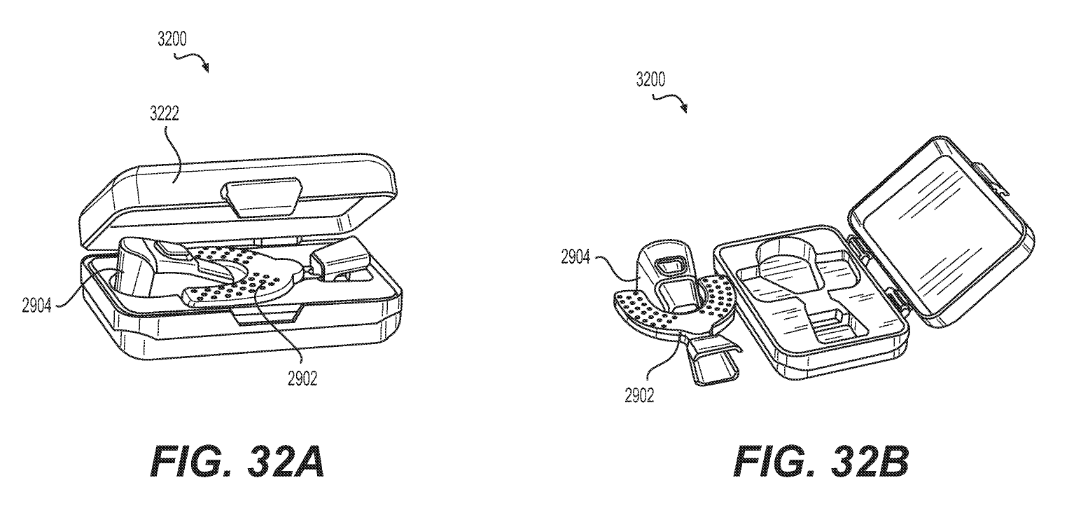

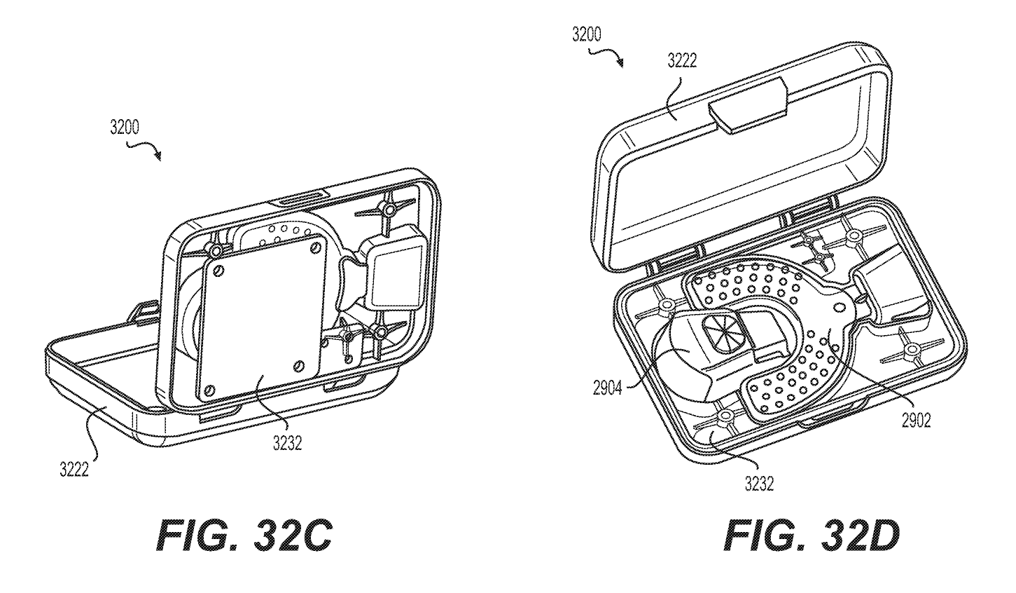

Another charging station 3200 is shown in FIGS. 32A-D. The charging station 3200 doubles as a case for the mouthpiece 2902 and base 2904. The charging station 3200 thus includes a lid 3222 configured to fully cover the base and protect the mouthpiece 2902 and base 2904. The bottom 3234 of the charging station 3200 can include specifically designed pockets configured to accommodate both the mouthpiece 2902 and the base 2904. The charging station 3200 can include a circuit board 3232 positioned near the base 2904. Further, the base can include a communication sensor, such as a light emitting diode (LED), radio-frequency identification (RFID), near field communication (NFC), or Bluetooth configured to communicate with the circuit board of the case. The communication sensor can, for example, signal when the base 2904 is in the charging station 3200 such that the charging station 3200 powers off when the base 2904 is not present so as to not draw power and expend unnecessary energy. The communication sensor can also be used to download and store information to the circuit board 3232, such as information regarding use of the mouthpiece.

In some embodiments, the dental device and/or charging stations described herein can be configured to work with an application for a cell phone, tablet, or computer. For example, a Bluetooth communication network can be established that allows stored information, such as usage information (length of use, time of use, etc.), to be transferred to the application. The application can have, for example, separate identifiers for separate patients (for example, when different mouthpieces are used for different patients with the same base). Further, in some embodiments, the communication network can be stopped or paused when the device is being vibrated and/or is otherwise in use.

In some embodiments, the dental devices, base, and/or charging station can be charged through induction (i.e., wireless) charging.

In some variations, the dental device may have visual methods of indicating to the user the state of the device. The device can have a light indicator. The indicator can be, for example, an LED light and can be configured to display one or more colors. In some embodiments, the light can be configured to change colors, light up for a set period of time, blink rapidly in a sequence of two, three, or four of the same color, and/or perform any of the previous functions in combination. The particular color or sequence of blinks can indicate a state of the device, such as that the device is on or off, that a vibration cycle is in progress and/or complete, that a treatment session has been interrupted, that the battery is full or low, and/or that the device is connected to an external device. For instance, a continuous blinking light of one color may indicate that a particular vibration cycle, such as a five minute cycle, is in progress. A three blink light of one color with a pause after the three blinks may be used to indicate that the cycle is complete. A three blink segment of a different color may also be used to indicate that the user has pressed the on/off switch prior to a treatment session being completed. Three blinks of a color may also be used to show that a treatment session has been interrupted and not completed within a set time window (e.g. 30 minutes). A different color light and number of blinks may be used to show that the dental device battery is low and recharging is required (e.g. blinks of a magenta light). A continuous light of one color may be used to indicate that the device has been plugged into a power source. A different continuously-lit light may be used to show that the device has been charged. Other light indicators may be used to show when the device is on/vibrating. In yet other example, a series of blinking lights of a particular color may be used to indicate that the user has connected the device's USB port to an external device. A series of blinking lights of a particular color may be used to show when a session has been interrupted and the device's USB port has been accessed within a predefine time window.

In one embodiment, the following signals can be used: (1) a blue light indicates that a 5-minute cycle is in progress; (2) a green light indicates that a 5-minute cycle is complete (3 blinks) or that the device is fully charged; (3) a red light indicates that the switch is pressed by the user before treatment is complete, that the 5 minute treatment is interrupted and not resumed within a 30 minute window, that the device is on/vibrating and the user connects to charger (in such a case, the vibration can also be automatically stopped), and/or that a 5-minute treatment is interrupted and the user connects to a charger within a 30 minute window; (4) a magenta light indicates that the device is at low battery level; and (5) an amber light indicates that the device is plugged into a charger.

In some embodiments, the dental device may include a motor ramp up sequence to help avoid jarring the patient by abruptly vibrating at the operating speed. When using the motor ramp up sequence, when the user presses the “ON” button on the dental device, the motor ramps up slowly to the operating frequency or acceleration. The amount of time that the dental device takes to reach the active session acceleration from the stand-by acceleration can be, for example, between 10 seconds and 60 seconds, such as between 20 seconds and 40 seconds, such as approximately 30 seconds.

In some embodiments, the dental devices described herein may include more than one motor, such as both a cylindrical and pancake motor. Such embodiments can have, for example, multiple modes of operation. One mode can work for acceleration of tooth movement, one mode can work for retention, one mode can work for seating, and/or one mode can work for remodeling. The modes can differ, for example, in frequencies of vibration, outputs, and/or load strains.

In some embodiments, the vibrating dental devices described herein can be used to strengthen the bone around teeth and tighten the ligaments around teeth such as for retention, e.g. orthodontic retention after braces are removed. For example, the device can be placed in the mouth for less than 10 minutes per day, such as less than 6 minutes, such as approximately 5 minutes, less than 5 minutes, or less than 1 minute per day for less than or equal to 180 days, less than or equal to 120 days, or less than or equal to 90 days to tighten the periodontal ligament after orthodontics. Such use can be in addition to or in place of traditional retainers. Use of the device can advantageously significantly decrease the time required for tightening of the periodontal ligament (from the average of six months to a year). Further, in some embodiments, the dental device can also be used for less than 2 minutes per day, such as less than 1 minute per day, on a continuing basis to provide general tooth strengthening. Further, the dental devices described herein can also be used for strengthening bone during dental implant procedures, tightening ligaments, strengthening bone after periodontics cleaning and procedures, such as after bone grafting.

In other embodiments, the vibrating devices described herein can be used to seat aligners, such as remodeling aligners (i.e., aligners designed to reposition teeth) like ClearCorrect™ or Invisalign™ and/or retention aligners (i.e., aligners designed to retain the final resulting tooth positions) such as Vivera™. In particular, the vibration imparted by the devices described herein can be used to move the aligner into the proper position over a patient's teeth, thereby enhancing the efficacy of the aligner treatment. Any of the dental devices described herein may be configured to aid with seating aligners. The dental devices can provide a particular level and duration of vibration to an aligner so as to gently agitate the aligner into the optimal position over the patient's teeth. The vibrations provided not only aid with seating the aligners over the occlusal regions of the wearer's teeth, but also aid with fitting the aligners over the entire surface of the wearer's teeth (including the buccal, lingual, mesial, distal, and interproximal surfaces of the teeth). In some embodiments, the acceleration is between 0.01 G to 1.0 G. In some embodiments, the frequency is between 60 Hz and 130 Hz, such as between 110 and 130 Hz, such as approximately 120 Hz.

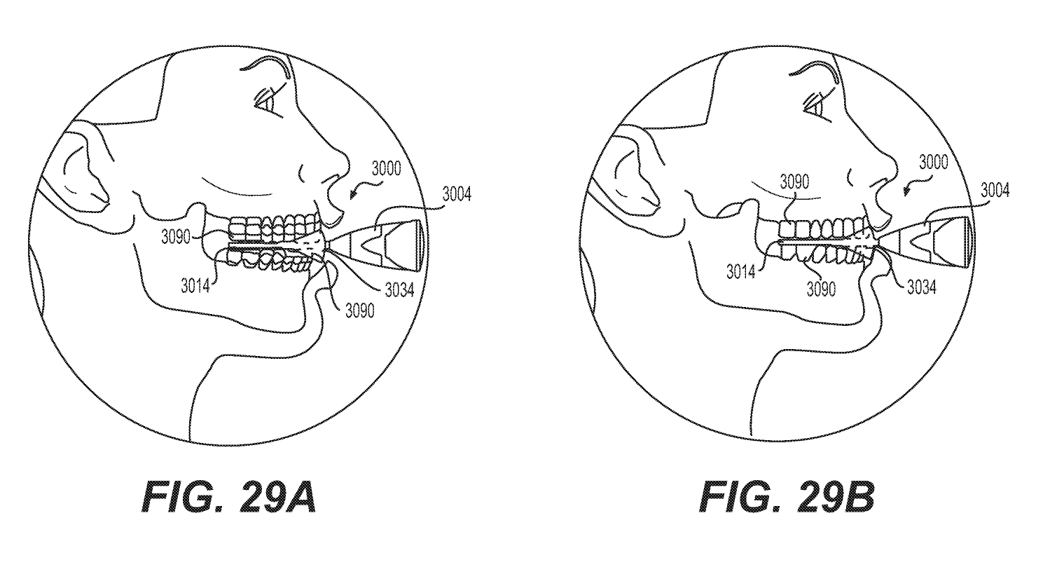

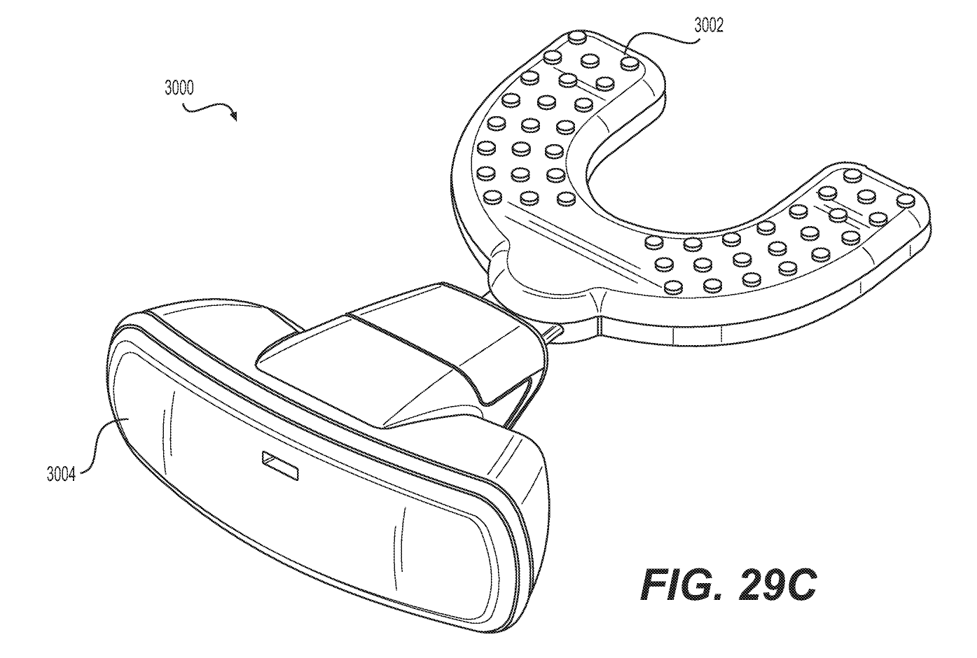

FIGS. 29A-29C show a dental device 3000. Dental device 3000 include a base 3004 attached to a mouthpiece 3002 that may include a biteplate 3014 and/or a mouth guard 3034. FIG. 29A shows typical aligners 3090 that are placed over a wearer's teeth. Prior to using the dental device 3000, the aligners 3090 are fitted over the wearer's teeth, but gaps remain between the wearer's teeth and the aligners 3090 even after the wearer has pushed down on the aligners 3090. FIG. 29B shows the interface between the aligners 3090 and the wearer's teeth after using dental device 3000. No gaps exist between the aligners 3090 and the wearer's teeth, and the aligners are evenly seated over the wearer's teeth. In other words, the vibration of the device 3000 can not only push the aligner against the teeth initially, but can also fully seat the aligner against the teeth, i.e., can conform the aligner tightly to the teeth without air gaps between the teeth and the aligner.

The dental device 3000 used for seating can be replaced with another embodiment of dental device described herein (such as that shown in FIGS. 30A-30G) and/or can include any combination of features of the various dental devices described herein.

The dental device 3000 (or any device for seating aligners) may include a mouthpiece that includes a mouth guard. The mouth guard can be shaped to contact only the occlusal surfaces of the aligners or can be shaped to contact substantially all of the primary surfaces of the aligner (e.g., can include a ridge or ledge extending off of the planar occlusal surfaces). A mouth guard that contacts all the primary surfaces of the aligner as fitted over a patient's teeth may be advantageous for not only seating the aligners from on top, but also for seating along the front facial surfaces and the back lingual surfaces. As with the biteplate, the mouth guard may be generic or customized for a particular patient. The mouth guard 3034 may also include a series of protrusions, indentations, dimples, channels that can aid in the gentle seating of the aligners upon application of vibration and acceleration. The protrusions, knobs, and dimples can press on the recessed regions along the surfaces of the aligners that may not have been reached by a flat biteplate or mouth piece. Further, the indentations and channels can prevent the dental device from pressing too hard on the regions of on the surface of the aligners that correspond to the rigid features of the patient's teeth.

In some variations, the biteplate or the mouth guard used for seating may include a soft, elastic cover. The soft, elastic cover may be removable from the biteplate or mouth guard, which can allow for easy cleaning as well, as replacement of the cover if it becomes cracked or damaged. The soft, elastic cover may also include surface variations such as protrusions, channels, indentations, and so forth for accommodating the uneven topography of the occlusal surfaces of the aligners.

In some examples, the mouthpiece used for seating may include a series of protrusions or indentations (e.g., as shown in FIG. 29C) that generally correspond to the protrusions or indentations of the aligners, which in turn may correspond to the molars and the surface ridges of the bicuspids, canines, and incisors. Having a biteplate with protrusions or indentations that correspond to the aligners can further aid in proper seating of the aligners. The biteplate may be generic or may be customized to fit a particular patient. In some cases, a patient may be able to obtain different sized mouthpieces for different users (for example, one biteplate might be used for multiple children or adults with a household undergoing teeth adjustment with the clear aligners).

In addition to the sensors described above that are able to detect vibration levels at the occlusal surfaces of the patient's teeth, the dental device may also include one or more pressure sensors on surfaces that contact the occlusal surface of aligners. The pressure sensors may detect, for example, when a wearer is not placing sufficient force onto the mouthpiece of the dental device and/or when a wearer is exerting too much force onto the mouthpiece by biting down too hard. While the mouthpiece may include one or more sensors to detect whether adequate force is being exerted on the mouthpiece, the mouthpiece may also include a plurality of sensors spaced throughout the mouthpiece and configured to indicate whether the wearer is applying equal pressure over the mouthpiece (and therefore over the aligner) or whether the wearer is applying too much force on one side and not enough on another. In some examples, the dental device can have an audio signal associated with when the device has been turned on and when inadequate pressure is being applied and a different-sounding audio signal from the device when too much pressure is being sensed at the sensor.

The device can also include one or more programs saved onto the dental device specifically for seating aligners (i.e., rather than for growing bone or repositioning bone). The programs for seating aligners may be different from those for growing bone, not only in vibrational frequency and acceleration, but also in duration and sequence of vibrations over the surfaces of the aligners. For example, a program using the dental device may be set to first simultaneously vibrate all regions corresponding to the occlusal areas of the aligners and then sequentially different regions over the aligners, at the same or different vibration and acceleration levels. The program may apply different frequencies that correspond to different programs for seating aligners in different scenarios. In some examples, there may be a requisite number of oscillations for completing a program (e.g. 36,000 oscillations within 5 minutes). The duration for the different sequence of vibrations may be anywhere from about one minute to about five minutes. The programs for seating aligners may have a different setting or different audio signal at the start and end of the session. The session may last from between one minute and five minutes to seat the aligners. Advantageously, the device can seat the aligner by vibrating for less than 5 minutes, such as less than 4 minutes, less than 3 minutes, or less than 2 minutes. In some embodiments, the device can have a quick-seat setting whereby the device vibrates for a shorter period of time (such as 30 to 90 seconds, e.g., approximately 1 minute) before automatically shutting off and a standard-seat seating whereby the device vibrates for a longer period of time (such as 3-6 minutes, e.g., approximately 5 minutes) before automatically shutting off. The quick-seat can be used, for example, throughout the day when aligners may be removed periodically while the standard-seat can be used before bed when the aligners will remain in place for a longer period of time.

As shown in FIGS. 29A and 29B, because the dental device 3000 extends across all of the teeth (and/or occlusal surfaces of the aligner), vibration can be applied simultaneously to all regions of the aligner at once, thereby simultaneously seating the aligner over all of the teeth in the dental arch at once and preventing distortion of the aligners (in contrast, for example, to Chewies™ aligner seaters that only applies force to specific localized spots on the occlusal surfaces of the aligners). Simultaneous alignment can advantageously lead to consistent seating of the aligner and minimize any gaps between the wearer's teeth and the aligners. Simultaneous alignment may also be more comfortable to the wearer because the vibrations are able to provide multi-directional forces for seating and may gently “wiggle” the aligners into a seated position as opposed to a singular downward force. The dental device 3000 can also advantageously vibrate at just the right frequency (e.g., high frequencies of over 100 Hz, such as 120 Hz) to seat the aligners quickly, easily, and consistently. The dental device 3000 advantageously does not require bite force (unlike, for example, Chewies™) and works through vibration alone. Use of the dental device 3000 for seating can reduce the time that the patient is required to wear aligners by ensuring that the aligners are properly positioned during use, thereby speeding up remodeling and/or retention. Further, use of the dental device 3000 for seating can help alleviate the pain associated with improperly seated aligners.

In some embodiments, the vibratory force for seating aligners can occur primarily on the occlusal surfaces of the aligners (i.e., with a mouthpiece that extends substantially parallel to the occlusal surface plane without a ridge or ledge around the edges to contact the lingual or buccal surfaces). In other embodiments, the vibratory force for seating aligners can occur on the occlusal, buccal, and lingual surfaces. In other embodiments, the stimulation can primarily occur on the lingual and/or buccal surfaces and not the occlusal surfaces.

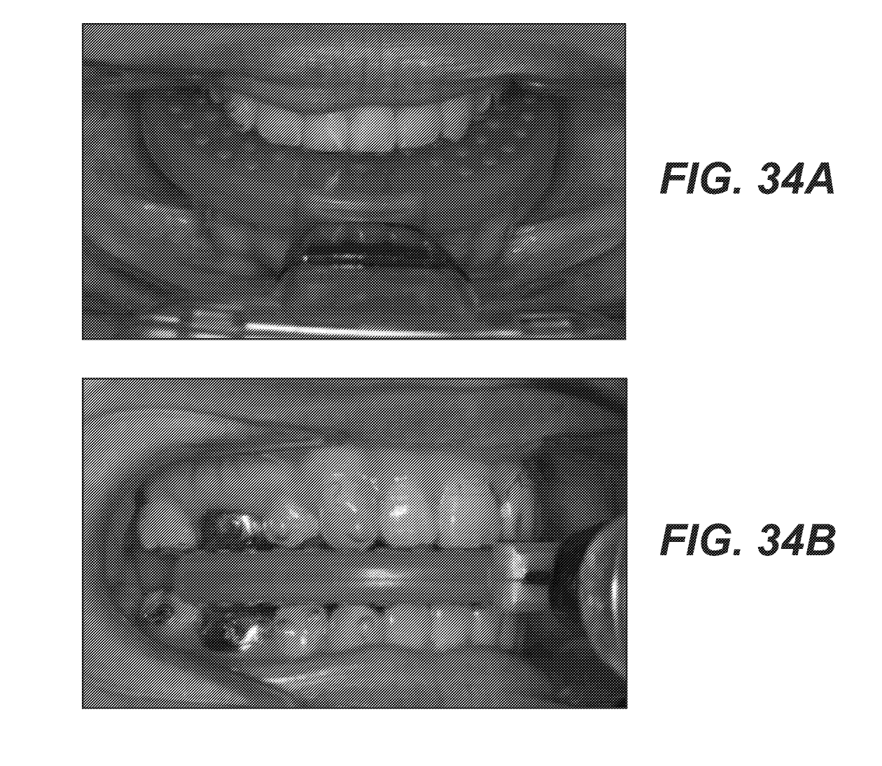

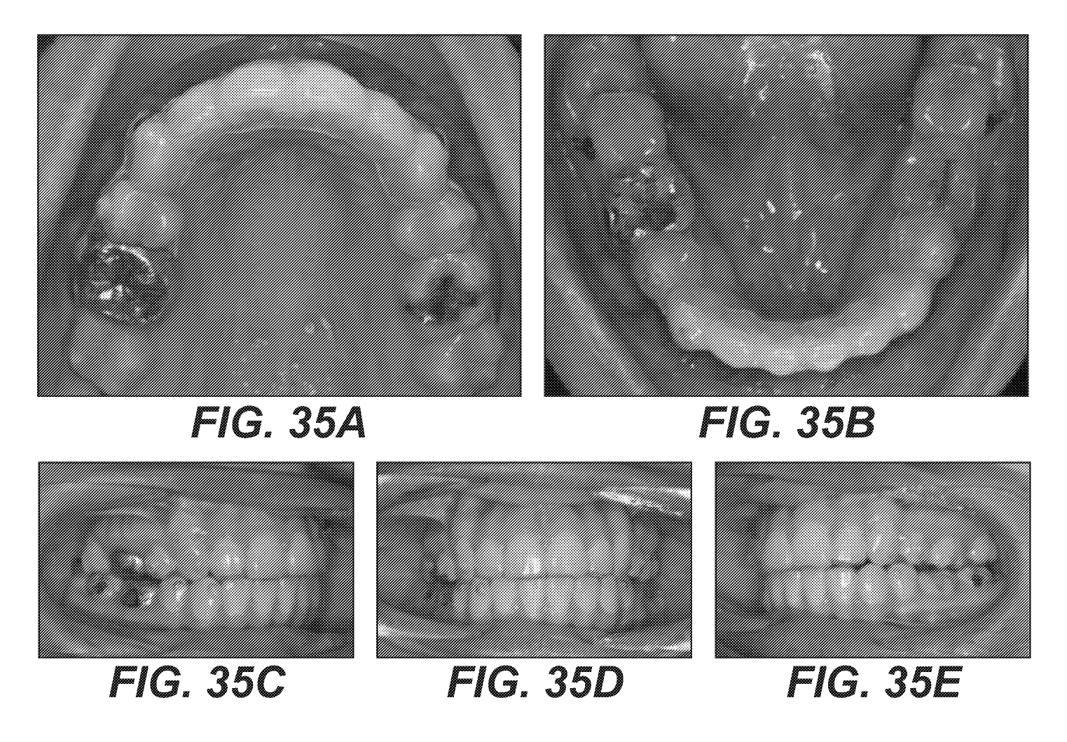

Exemplary results from use of a vibration device as described herein to seat aligners is shown with respect to FIGS. 34A-35E. In this embodiment, an aligner was used, and the vibration device, vibrating at 120 Hz, was used by the patient before bed for 5 minutes with the aligner in place (see FIGS. 34A-34B). As shown in FIGS. 35A-35E, the aligners were seated perfectly after use of the vibration device. The case was completed (i.e., the teeth were fully remodeled) in 20 weeks, and no refinement was needed. Lower crowding was resolved, and Class II canines were corrected with Class II elastics to a Class I relationship.

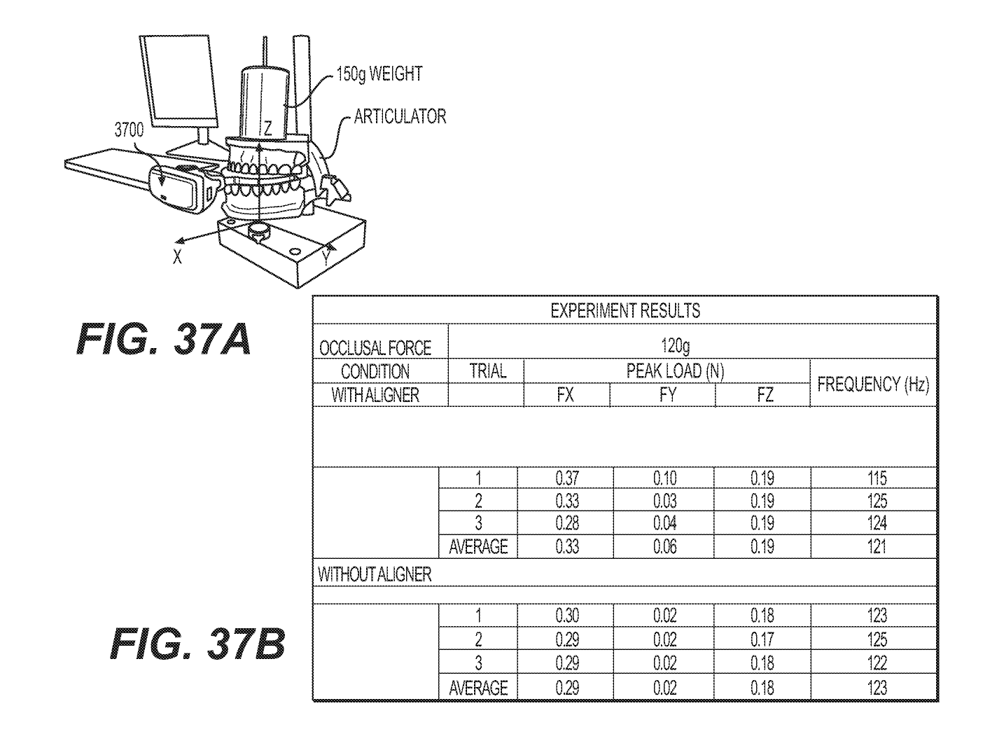

Exemplary test results indicating the forces applied when seating aligners with a vibration device as described herein are shown with respect to FIGS. 37A-37B. In this embodiment, a stand was designed to fix the articulator to a desired height. A lower arch model was attached to the articulator, and an upper arch model was aligned to the articulator without direct connection. This ensured the correct occlusal positions of the two arches. The upper surface of the upper arch was attached to the load cell. To ease the testing, the entire assembly was placed in an upside down position with the maxilla (upper arch) being at the bottom. The load cell was placed to the base plate of the stand. The x-axis of the load cell was in the sagittal direction, the y-axis was parallel to the articulator's axis, and the z-axis was in the vertical direction (apical-occlusal direction). The coordinate definitions are shown in 37A. The lower arch was placed on top of the upper arch. The articulator allows it moving around the hinge of the articulator simulating jaw opening/closing. The vibration device 3700 was placed between the upper and the lower arch models. A weight was placed on the top of the lower arch simulating the biting force. The load cell was powered by an electronic device, and the data was collected by a computer. The sample rate was set at 500 Hz. The forces in each direction were determined both with and without aligners. FIG. 37B shows the resulting forces. As shown in FIG. 37B, the device 3700 generated force in primarily Fx and Fz, meaning that the resultant force is closely in the sagittal (x-z) plane. Advantageously, having the resultant force in the sagittal plane allows proper seating of aligners without dislodging the aligners (which could otherwise occur if the force were in all of the Fx, Fy, and Fx directions).

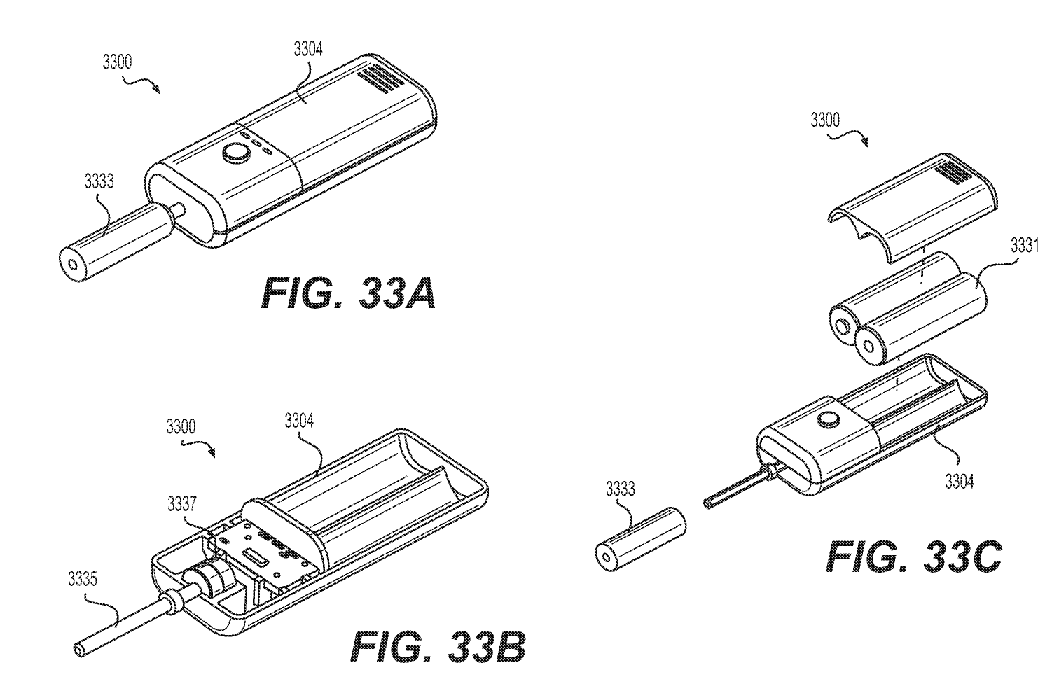

An exemplary device 3300 designed to work for seating aligners is shown in FIGS. 33A-33C. In this embodiment, the base 3304 includes a battery 3331, motor 3337, and drive pin 3335. The motor 3333 is configured to vibrate the drive pin 3335. A plastic cylindrical piece 3333 is configured to be attached and detached from the drive pin 335 during regular use. The cylindrical piece 333 can be made, for example, of a foam or spongy plastic, such as styrene copolymer. In some embodiments, the cylindrical piece 333 can be a Chewiest™ that is placed on the drive pin 335. The cylindrical piece 3333 can be placed on the drive pin 335 and vibrated against the occlusal surfaces of the aligners (as described herein) so as to allow for aligner seating without requiting a chewing motion by the user. After use, the cylindrical piece 3333 can be removed.

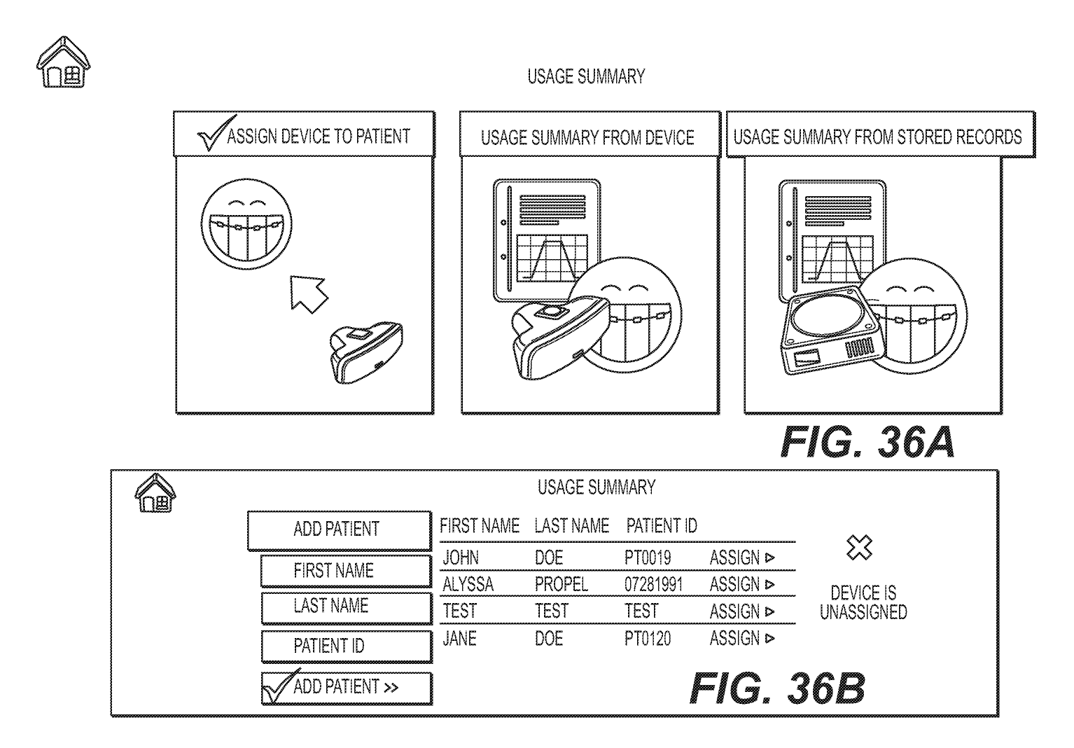

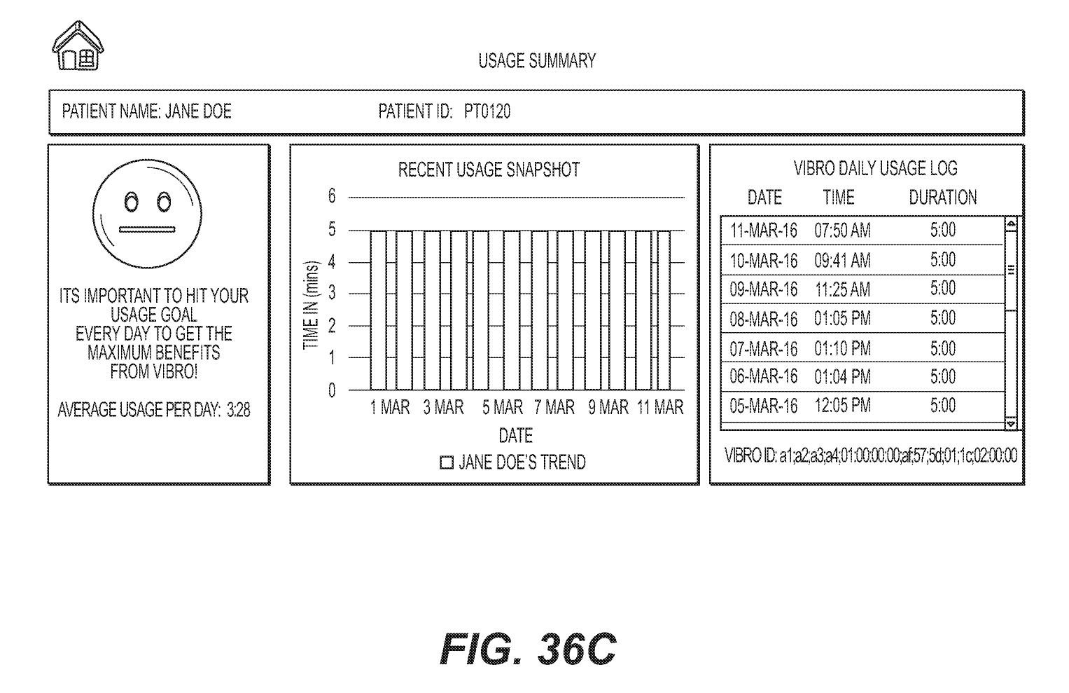

In some embodiments, the devices described herein can be used with a software application, such as with a cell phone, tablet, or computer. An exemplary user interface for use of the device is seating aligners is shown in FIGS. 36A-36C. For examples, the user can connect the vibration device to the software (through usb, Bluetooth, etc.). At FIG. 36A, the user interface can allow choice of assignment of the device to a patient, usage summary from the device, or usage summary from stored records. At FIG. 36B, the user can assign a device or mouthpiece of the device to a patient (more than one patient can use the same device, for example, with a different mouthpiece). At FIG. 36C, the user interface can show the dates and time of use and the overall usage goal. Advantageously, usage data can help increase patient use compliance (e.g., compliance with an aligner seating and/or retention protocol).

In some embodiments, the vibrating devices described herein can be used in aiding dental implant integration (e.g., endosseous implants). That is, use of the devices described herein can promote gone regrowth around the dental implant to secure the implant in place. The vibration sessions for aiding implant integration may be the same or different than the programs for seating aligners. In one embodiment, the dental device is programmed to have an acceleration of 0.3 G and a frequency of 60 Hz. In another embodiment, the dental device is programmed to have an acceleration of 0.6 G, a frequency of 60 Hz. The vibration sessions for implant integration can be programmed to run for a few minutes (e.g. 3-8 minutes). The dental devices described herein may have a control option for selecting the desired implant integration program. In some instances, the dental device can be configured to apply vibration on a specific quadrant of the mouth so as to more precisely target an area in the mouth that is suffering from alveolar bone loss.

In some embodiments, the vibration of the dental devices described herein can be used to stimulate the periodontal ligament and/or soft tissues, causing recruitment of cells into the soft tissue that facilitate tooth movement if under pressure from aligners and/or other orthodontic devices. In some embodiments, the vibration can also stimulate mitochondria in soft tissue and bone cells, which can likewise result in facilitation of orthodontic treatments.

It is to be understood that the various elements of the mouthpieces and bases described herein with reference to specific embodiments could be substitute and/or combined with any other embodiment(s) described herein.

Additional details pertinent to the present invention, including materials and manufacturing techniques, may be employed as within the level of those with skill in the relevant art. The same may hold true with respect to method-based aspects of the invention in terms of additional acts commonly or logically employed. Also, it is contemplated that any optional feature of the inventive variations described may be set forth and claimed independently, or in combination with any one or more of the features described herein. Likewise, reference to a singular item, includes the possibility that there are a plurality of the same items present. More specifically, as used herein and in the appended claims, the singular forms “a,” “and,” “said,” and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Unless defined otherwise herein, all technical and scientific terms used herein have the same meaning as commonly understood by one of ordinary skill in the art to which this invention belongs. The breadth of the present invention is not to be limited by the subject specification, but rather only by the plain meaning of the claim terms employed.

1-41. (canceled)

42. A method for seating orthodontic aligners into a desired position, the method comprising:
providing a vibrational dental device having a mouthpiece configured to vibrate at a frequency between 60 Hz and 130 Hz such; and
providing instructions for using the vibrational dental device to seat an orthodontic aligner against occlusal surfaces of a user' teeth, the instructions comprising
placing the orthodontic aligner over the occlusal surfaces of the user' teeth;
placing the mouthpiece into the oral cavity of the user against the orthodontic aligner; and
applying, by vibrating the mouthpiece, an axial vibratory force on the orthodontic aligner.

43. The method of claim 42, further comprising providing instructions for using the vibrational dental device for less than 5 minutes daily over a period of time.

44. The method of claim 43, further comprising providing instructions for using the vibrational dental device for less than 5 minutes daily over less than 14 days.

45. The method of claim 42, further comprising providing instructions for vibrating the mouthpiece against all of the user's teeth that are covered with the orthodontic aligner.

46. The method of claim 42, wherein the axial vibratory force is primarily along a sagittal plane of the user's mouth.

47. The method of claim 42, further comprising providing instructions for configuring the mouthpiece to vibrate at an acceleration magnitude ranging between 0.01 G and 1 G.

48. The method of claim 42, further comprising providing instructions for configuring the mouthpiece to vibrate at a frequency lower than 130 Hz.

49. The method of claim 48, further comprising providing instructions for configuring the mouthpiece to vibrate at a frequency between 100 Hz and 120 Hz.

50. A method of improving osseointegration of oral implants, the method comprising:
obtaining a vibrational dental device comprising a mouthpiece configured to vibrate at a frequency between 60 Hz and 130 Hz;
placing the mouthpiece over the occlusal surfaces of a user's teeth that includes an oral implant;
vibrating the mouthpiece to apply an axial vibratory force on the occlusal surface of the oral implant for about less than five minutes daily;
wherein the axial vibratory force promotes bone growth around the oral implant.

51. The method of claim 50, further comprising vibrating the mouthpiece at an acceleration magnitude ranging between 0.01 G and 1 G.

52. The method of claim 50, further comprising vibrating the mouthpiece at a frequency lower than 130 Hz.

53. The method of claim 50, further comprising vibrating the mouthpiece at a frequency between 100 Hz and 120 Hz.

54. The method of claim 50, wherein the axial vibratory force is primarily along a sagittal plane of the user's mouth.

55. A method for orthodontic retention in aligner treatment, the method comprising:
obtaining a vibrational dental device comprising a mouthpiece configured to vibrate at a frequency between 60 Hz and 130 Hz;
placing the mouthpiece over the occlusal surfaces of a user's teeth in aligner treatment;
vibrating the mouthpiece to apply an axial vibratory force on the occlusal surface of the user's teeth for about less than five minutes daily; and
increasing bone growth and tightening periodontal ligament around the user's teeth for orthodontic retention.

56. The method of claim 55, further comprising vibrating the mouthpiece at an acceleration magnitude ranging between 0.01 G and 1 G.

57. The method of claim 55, further comprising vibrating the mouthpiece at a frequency lower than 130 Hz.

58. The method of claim 57, further comprising vibrating the mouthpiece at a frequency between 100 Hz and 120 Hz.

59. The method of claim 55, wherein the axial vibratory force is primarily along a sagittal plane of the user's mouth.
